(19) United States
(12) Patent Application Publication
(10) Pub. No.: US 2024/0323828 A1
(43) Pub. Date: Sep. 26, 2024

(54) METHOD OF AF APPARATUS, METHOD OF NEF APPARATUS, METHOD OF UDM APPARATUS, METHOD OF AMF APPARATUS, METHOD OF UE, METHOD OF PCF APPARATUS, METHOD OF RAN NODE, AF APPARATUS, NEF APPARATUS, UDM APPARATUS, AMF APPARATUS, UE, PCF APPARATUS AND RAN NODE

(71) Applicant: NEC Corporation, Minato-ku, Tokyo (JP)

(72) Inventors: Iskren Ianev, Tokyo (JP); Toshiyuki Tamura, Tokyo (JP); Kundan Tiwari, Tokyo (JP)

(73) Assignee: NEC Corporation, Minato-ku, Tokyo (JP)

(21) Appl. No.: 18/698,845

(22) PCT Filed: Oct. 26, 2022
(86) PCT No.: PCT/JP2022/039978

§ 371 Date: Apr. 5, 2024

(30) Foreign Application Priority Data
Nov. 5, 2021 (IN) 202111050762

(51) Int. Cl. H04W 48/18; H04W 36/06; H04W 48/16; H04W 60/04

(52) U.S. Cl. CPC H04W 48/18; H04W 36/06; H04W 48/16; H04W 60/04

(57) ABSTRACT

One of the outstanding problems is how and in what format the 5GS network (or another network node) provides the network slice priority information and network slice grouping information to the UE and to other network nodes so that the UE can perform cell selection and cell reselection based on the network slice priority and network slice grouping information. This includes the provision of the network slice priority and possible network slice grouping to the 5GS itself in case of network slices owned by external service provider.

A method of an Application Function (AF) apparatus includes changing a priority related to Single Network Slice Selection Assistance Information (S-NSSAI), and sending the priority to a Network Exposure Function (NEF) apparatus.

### TECHNICAL FIELD

This present disclosure relates to a method of an Application Function (AF) apparatus, a method of a Network Exposure Function (NEF) apparatus, a method of a Unified Data Management (UDM) apparatus, a method of an Access and Mobility Management Function (AMF) apparatus, a method of a User Equipment (UE), a method of a Policy Control Function (PCF) apparatus, a method of a Radio Access Network (RAN) node, an AF apparatus, a NEF apparatus, UDM apparatus, an AMF apparatus, a UE, a PCF apparatus and a RAN node.

### BACKGROUND ART

In the 3GPP RAN WG2 #115-e meeting, NPL 2 was agreed. This document discloses the following technical aspects.

The following information will be used in UE AS for cell reselection evaluation:
Slice specific absolute priority of each of the frequency supporting a slice (“Slice Info”)
   The UE receives slice info using RRC signaling (System Information and/or dedicated RRC signaling)
List of Slices with Slice Priority for cell reselection.

For the List of Slices with Slice Priority, UE Access Stratum (AS) expects to receive a list from NAS containing a slice priority for each of the slices contained in the list when/before it moves to RRC_IDLE/RRC_INACTIVE and when the list and/or priorities changes while the UE is in RRC_IDLE/RRC_INACTIVE.

This cell reselection evaluation is designed based on the following designed principle.
Frequency priority mapping for each slice (slice->frequency(ies)->absolute priority of each of the frequency) is provided to a UE.
Frequency priority mapping for each of the slice (slice->frequency(ies)->absolute priority of each of the frequency) is part of the “slice info” agreed to be provided to the UE using both broadcast and dedicated signaling.

In addition, the Slice Group concept was also disclosed, where a slice group consists of one or multiple slices, one slice belongs to one and only one slice group and each slice group is uniquely identified by a slice group identifier.

### CITATION LIST

### Non Patent Literature

[NPL 1] 3GPP TR 21.905: “Vocabulary for 3GPP Specifications”. V17.0.0 (2020-07)
[NPL 2] 3GPP RAN WG2 #115-e meeting R2-2108928: “LS on Slice list and priority information for cell reselection”. (2021-08)
[NPL 3] IETF RFC 5580: “Carrying Location Objects in RADIUS and Diameter”. (2009-08)
[NPL 4] 3GPP TS 29.214: “Policy and Charging Control over Rx reference point”. V17.1.0 (2021-09)

### SUMMARY OF INVENTION

### Technical Problem

One of the outstanding problems is how and in what format the 5GS network (or another network node) provides the network slice priority information and network slice grouping information to the UE and to other network nodes so that the UE can perform cell selection and cell reselection based on the network slice priority and network slice grouping information. This includes the provision of the network slice priority and possible network slice grouping to the 5GS itself in case of network slices owned by external service provider.

### Solution to Problem

In an aspect of the present disclosure, a method of an Application Function (AF) apparatus includes changing a priority related to Single Network Slice Selection Assistance Information (S-NSSAI), and sending the priority to a Network Exposure Function (NEF) apparatus.

In an aspect of the present disclosure, a method of a Network Exposure Function (NEF) apparatus includes receiving a priority related to Single Network Slice Selection Assistance Information (S-NSSAI) from an Application Function (AF) apparatus, and sending the priority to a Unified Data Management (UDM) apparatus.

In an aspect of the present disclosure, a method of a Unified Data Management (UDM) apparatus includes receiving a priority related to Single Network Slice Selection Assistance Information (S-NSSAI) from a Network Exposure Function (NEF) apparatus, and storing the priority.

In an aspect of the present disclosure, a method of an Access and Mobility Management Function (AMF) apparatus includes receiving a registration request message from a User Equipment (UE), sending Subscription Permanent Identifier (SUPI) related to the UE to a Unified Data Management (UDM) apparatus, receiving a priority related to Single Network Slice Selection Assistance Information (S-NSSAI) from the UDM apparatus, and sending, to the UE, a registration accept message including the priority.

In an aspect of the present disclosure, a method of an Access and Mobility Management Function (AMF) apparatus includes receiving a priority related to Single Network Slice Selection Assistance Information (S-NSSAI) from a Unified Data Management (UDM) apparatus, and sending, to a User Equipment (UE), a UE Configuration Update message including the priority.

In an aspect of the present disclosure, a method of a User Equipment (UE) includes sending a registration request message including information which indicates the UE supports a priority related to Single Network Slice Selection Assistance Information (S-NSSAI), and receiving a registration accept message including the priority.

In an aspect of the present disclosure, a method of a Policy Control Function (PCF) apparatus includes receiving a priority related to Single Network Slice Selection Assistance Information (S-NSSAI) from a Unified Data Management (UDM) apparatus, updating a policy based on the priority, and sending the policy.

In an aspect of the present disclosure, a method of an Access and Mobility Management Function (AMF) apparatus includes receiving a policy including a priority related to Single Network Slice Selection Assistance Information (S-NSSAI) from a Policy Control Function (PCF) apparatus, and sending the policy to a User Equipment (UE).

In an aspect of the present disclosure, a method of an Access and Mobility Management Function (AMF) apparatus includes receiving Single Network Slice Selection Assistance Information (S-NSSAI) and a priority related to the S-NSSAI from a Unified Data Management (UDM) apparatus, and sending, to a Radio Access Network (RAN) node, an N2 message including the S-NSSAI and the priority.

In an aspect of the present disclosure, A method of a Radio Access Network (RAN) node includes receiving Single Network Slice Selection Assistance Information (S-NSSAI) and a priority related to the S-NSSAI from an Access and Mobility Management Function (AMF) apparatus, and using the priority for a process related to handover or a process related to a PDU Session.

In an aspect of the present disclosure, an Application Function (AF) apparatus includes means for changing a priority related to Single Network Slice Selection Assistance Information (S-NSSAI), and means for sending the priority to a Network Exposure Function (NEF) apparatus.

In an aspect of the present disclosure, a Network Exposure Function (NEF) apparatus includes means for receiving a priority related to Single Network Slice Selection Assistance Information (S-NSSAI) from an Application Function (AF) apparatus, and means for sending the priority to a Unified Data Management (UDM) apparatus.

In an aspect of the present disclosure, a Unified Data Management (UDM) apparatus includes means for receiving a priority related to Single Network Slice Selection Assistance Information (S-NSSAI) from a Network Exposure Function (NEF) apparatus, and means for storing the priority.

In an aspect of the present disclosure, An Access and Mobility Management Function (AMF) apparatus includes means for receiving a registration request message from a User Equipment (UE), means for sending Subscription Permanent Identifier (SUPI) related to the UE to a Unified Data Management (UDM) apparatus, means for receiving a priority related to Single Network Slice Selection Assistance Information (S-NSSAI) from the UDM apparatus, and means for sending, to the UE, a registration accept message including the priority.

In an aspect of the present disclosure, an Access and Mobility Management Function (AMF) apparatus includes means for receiving a priority related to Single Network Slice Selection Assistance Information (S-NSSAI) from a Unified Data Management (UDM) apparatus, and means for sending, to a User Equipment (UE), a UE Configuration Update message including the priority.

In an aspect of the present disclosure, a User Equipment (UE) includes means for sending a registration request message including information which indicates the UE supports a priority related to Single Network Slice Selection Assistance Information (S-NSSAI), and means for receiving a registration accept message including the priority.

In an aspect of the present disclosure, a Policy Control Function (PCF) apparatus includes means for receiving a priority related to Single Network Slice Selection Assistance Information (S-NSSAI) from a Unified Data Management (UDM) apparatus, means for updating a policy based on the priority, and means for sending the policy.

In an aspect of the present disclosure, an Access and Mobility Management Function (AMF) apparatus includes means for receiving a policy including a priority related to Single Network Slice Selection Assistance Information (S-NSSAI) from a Policy Control Function (PCF) apparatus, and means for sending the policy to a User Equipment (UE).

In an aspect of the present disclosure, an Access and Mobility Management Function (AMF) apparatus includes means for receiving Single Network Slice Selection Assistance Information (S-NSSAI) and a priority related to the S-NSSAI from a Unified Data Management (UDM) apparatus, and means for sending, to a Radio Access Network (RAN) node, an N2 message including the S-NSSAI and the priority.

In an aspect of the present disclosure, a Radio Access Network (RAN) node includes means for receiving Single Network Slice Selection Assistance Information (S-NSSAI) and a priority related to the S-NSSAI from an Access and Mobility Management Function (AMF) apparatus, and means for using the priority for a process related to handover or a process related to a PDU Session.

### BRIEF DESCRIPTION OF DRAWINGS

FIG. 1 illustrates new information in the User equipment (UE) for a cell selection and a cell reselection

FIG. 2 illustrates slice information

FIG. 3 is a signaling diagram of a first example of the first Aspect.

FIG. 4 is a signaling diagram of a first example of the second Aspect.

FIG. 5 is a signaling diagram of a second example of the second Aspect.

FIG. 6 is a signaling diagram of a third example of the second Aspect.

FIG. 7 is a signaling diagram of a fourth example of the second Aspect.

FIG. 8 is a signaling diagram of a first example of the third Aspect.

FIG. 9 is a diagram illustrating a system overview.

FIG. 10 is a block diagram illustrating a User equipment (UE).

FIG. 11 is a block diagram illustrating an (R)AN node.

FIG. 12 is a diagram illustrating System overview of (R)AN node based on O-RAN architecture.

FIG. 13 is a block diagram illustrating a Radio Unit (RU).

FIG. 14 is a block diagram illustrating a Distributed Unit (DU).

FIG. 15 is a block diagram illustrating a Centralized Unit (CU).

FIG. 16 is a block diagram illustrating an Access and Mobility Management Function (AMF).

FIG. 17 is a block diagram illustrating a Policy Control Function (PCF).

FIG. 18 is a block diagram illustrating a Network Exposure Function (NEF).

FIG. 19 is a block diagram illustrating a Unified Data Management (UDM).

FIG. 20 is a block diagram illustrating an Application Function (AF).

### DESCRIPTION OF EMBODIMENTS

### Abbreviations

For the purposes of the present document, the abbreviations given in NPL 1 and the following apply. An abbreviation defined in the present document takes precedence over the definition of the same abbreviation, if any, in NPL 1.

| | |
|---|---|
| 4G-GUTI | 4G Globally Unique Temporary UE Identity |
| 5GC | 5G Core Network |
| 5GLAN | 5G Local Area Network |
| 5GS | 5G System |
| 5G-AN5G | Access Network |
| 5G-AN PDB | 5G Access Network Packet Delay Budget |
| 5G-EIR | 5G-Equipment Identity Register |
| 5G-GUTI | 5G Globally Unique Temporary Identifier |
| 5G-BRG | 5G Broadband Residential Gateway |
| 5G-CRG | 5G Cable Residential Gateway |
| 5G GM | 5G Grand Master |
| 5G-RG5G | Residential Gateway |
| 5G-S-TMSI | 5G S-Temporary Mobile Subscription Identifier |
| 5G VN | 5G Virtual Network |
| 5QI | 5G QoS Identifier |
| AF | Application Function |
| AMF | Access and Mobility Management Function |
| AMF-G | Geographically selected Access and Mobility |
| | Management Function |
| AMF-NG | Non-Geographically selected Access and Mobility |
| | Management Function |
| AS | Access Stratum |
| ATSSS | Access Traffic Steering, Switching, Splitting |
| ATSSS-LL | ATSSS Low-Layer |
| AUSF | Authentication Server Function |
| AUTN | Authentication token |
| BMCA | Best Master Clock Algorithm |
| BSF | Binding Support Function |
| CAG | Closed Access Group |
| CAPIF | Common API Framework for 3GPP northbound |
| | APIs |
| CHF | Charging Function |
| CN PDB | Core Network Packet Delay Budget |
| CP | Control Plane |
| DAPS | Dual Active Protocol Stacks |
| DL | Downlink |
| DN | Data Network |
| DNAI | DN Access Identifier |
| DNN | Data Network Name |
| DRX | Discontinuous Reception |
| DS-TT | Device-side TSN translator |
| ePDG | evolved Packet Data Gateway |
| EBI | EPS Bearer Identity |
| EPS | Evolved Packet System |
| EUI | Extended Unique Identifier |
| FAR | Forwarding Action Rule |
| FN-BRG | Fixed Network Broadband RG |
| FN-CRG | Fixed Network Cable RG |
| FN-RG | Fixed Network RG |
| FQDN | Fully Qualified Domain Name |
| GFBR | Guaranteed Flow Bit Rate |
| GMLC | Gateway Mobile Location Centre |
| GPSI | Generic Public Subscription Identifier |
| GUAMI | Globally Unique AMF Identifier |
| GUTI | Globally Unique Temporary UE Identity |
| HR | Home Routed (roaming) |
| IAB | Integrated access and backhaul |
| IMEI/TAC | IMEI Type Allocation Code |
| IPUPS | Inter PLMN UP Security |
| I-SMF | Intermediate SMF |
| I-UPF | Intermediate UPF |
| LADN | Local Area Data Network |
| LBO | Local Break Out (roaming) |
| LMF | Location Management Function |
| LoA | Level of Automation |
| LPP | LTE Positioning Protocol |
| LRF | Location Retrieval Function |
| MCC | Mobile country code |
| MCX | Mission Critical Service |
| MDBV | Maximum Data Burst Volume |
| MFBR | Maximum Flow Bit Rate |
| MICO | Mobile Initiated Connection Only |
| MITM | Man In the Middle |
| MNC | Mobile Network Code |
| MPS | Multimedia Priority Service |
| MPTCP | Multi-Path TCP Protocol |
| N3IWF | Non-3GPP InterWorking Function |
| N3GPP | Non-3GPP access |
| N5CW | Non-5G-Capable over WLAN |
| NAI | Network Access Identifier |
| NAS | Non-Access-Stratum |
| NEF | Network Exposure Function |
| NF | Network Function |
| NGAP | Next Generation Application Protocol |
| NID | Network identifier |
| NPN | Non-Public Network |
| NR | New Radio |
| NRF | Network Repository Function |
| NSI ID | Network Slice Instance Identifier |
| NSSAA | Network Slice-Specific Authentication and |
| | Authorization |
| NSSAAF | Network Slice-Specific Authentication and |
| | Authorization Function |
| NSSAI | Network Slice Selection Assistance Information |
| NSSF | Network Slice Selection Function |
| NSSP | Network Slice Selection Policy |
| NSSRG | Network Slice Simultaneous Registration Group |
| NW-TT | Network-side TSN translator |
| NWDAF | Network Data Analytics Function |
| PCF | Policy Control Function |
| PDB | Packet Delay Budget |
| PDR | Packet Detection Rule |
| PDU | Protocol Data Unit |
| PEI | Permanent Equipment Identifier |
| PER | Packet Error Rate |
| PFD | Packet Flow Description |
| PLMN | Public Land Mobile Network |
| PNI-NPN | Public Network Integrated Non-Public Network |
| PPD | Paging Policy Differentiation |
| PPF | Paging Proceed Flag |
| PPI | Paging Policy Indicator |
| PSA | PDU Session Anchor |
| PTP | Precision Time Protocol |
| QFI | QoS Flow Identifier |
| QoE | Quality of Experience |
| RACS | Radio Capabilities Signalling optimisation |
| (R)AN | (Radio) Access Network |
| RG | Residential Gateway |
| RIM | Remote Interference Management |
| RQA | Reflective QoS Attribute |
| RQI | Reflective QoS Indication |
| RSN | Redundancy Sequence Number |
| SA NR | Standalone New Radio |
| SBA | Service Based Architecture |
| SBI | Service Based Interface |
| SCP | Service Communication Proxy |
| SD | Slice Differentiator |
| SEAF | Security Anchor Functionality |
| SEPP | Security Edge Protection Proxy |
| SMF | Session Management Function |
| SMSF | Short Message Service Function |
| SN | Sequence Number |
| SN name | Serving Network Name. |
| SNPN | Stand-alone Non-Public Network |
| S-NSSAI | Single Network Slice Selection Assistance |
| | Information |
| SSC | Session and Service Continuity |
| SSCMSP | Session and Service Continuity Mode |
| | Selection Policy |
| SST | Slice/Service Type |
| SUCI | Subscription Concealed Identifier |
| SUPI | Subscription Permanent Identifier |
| SV | Software Version |
| TMSI | Temporary Mobile Subscriber Identity |
| TNAN | Trusted Non-3GPP Access Network |
| TNAP | Trusted Non-3GPP Access Point |
| TNGF | Trusted Non-3GPP Gateway Function |
| TNL | Transport Network Layer |
| TNLA | Transport Network Layer Association |
| TSC | Time Sensitive Communication |
| TSC AI | TSC Assistance Information |
| TSN | Time Sensitive Networking |
| TSN GM | TSN Grand Master |
| TSP | Traffic Steering Policy |
| TT | TSN Translator |
| TWIF | Trusted WLAN Interworking Function |
| UCMF | UE radio Capability Management Function |
| UDM | Unified Data Management |
| UDR | Unified Data Repository |
| UDSF | Unstructured Data Storage Function |
| UE | User Equipment |
| UL | Uplink |
| UL CL | Uplink Classifier |
| UPF | User Plane Function |
| URLLC | Ultra Reliable Low Latency Communication |
| URRP-AMF | UE Reachability Request Parameter for AMF |
| URSP | UE Route Selection Policy |
| VID | VLAN Identifier |
| VLAN | Virtual Local Area Network |
| VPLMN | Visited PLMN |
| W-5GAN | Wireline 5G Access Network |
| W-5GBAN | Wireline BBF Access Network |
| W-5GCAN | Wireline 5G Cable Access Network |
| W-AGF | Wireline Access Gateway Function |

### Definitions

For the purposes of the present document, the terms and definitions given in NPL 1 and the following apply. A term defined in the present document takes precedence over the definition of the same term, if any, in NPL 1.

### General

Those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the Aspects of the present disclosure so as not to obscure the figures with details that will be readily apparent to those skilled in the art having the benefit of the description herein.

For the purpose of promoting an understanding of the principles of the disclosure, reference will now be made to the Aspect illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more devices or entities or sub-systems or elements or structures or components preceded by “comprises . . . a” does not, without more constraints, preclude the existence of other devices, sub-systems, elements, structures, components, additional devices, additional sub-systems, additional elements, additional structures or additional components. Appearances of the phrase “in an Aspect”, “in another Aspect” and similar language throughout this specification may, but not necessarily do, all refer to the same Aspect.

Unless otherwise defined, all technical and scientific terms used herein have the same meaning as commonly understood by those skilled in the art to which this disclosure belongs. The system, methods, and examples provided herein are only illustrative and not intended to be limiting.

In the following specification and the claims, reference will be made to a number of terms, which is defined to have the following meanings. The singular forms “a”, “an”, and “the” include plural references unless the context clearly dictates otherwise.

As used herein, information is associated with data and knowledge, as data is meaningful information and represents the values attributed to parameters. Further knowledge signifies understanding of an abstract or concrete concept. Note that this example system is simplified to facilitate description of the disclosed subject matter and is not intended to limit the scope of this disclosure. Other devices, systems, and configurations may be used to implement the Aspects disclosed herein in addition to, or instead of, a system, and all such Aspects are contemplated as within the scope of the present disclosure.

Each of Aspects and elements included in each Aspects described below may be implemented independently or in combination with any other. These Aspects include novel characteristics different from one another. Accordingly, these Aspects contribute to achieving objects or solving problems different from one another and contribute to obtaining advantages different from one another.

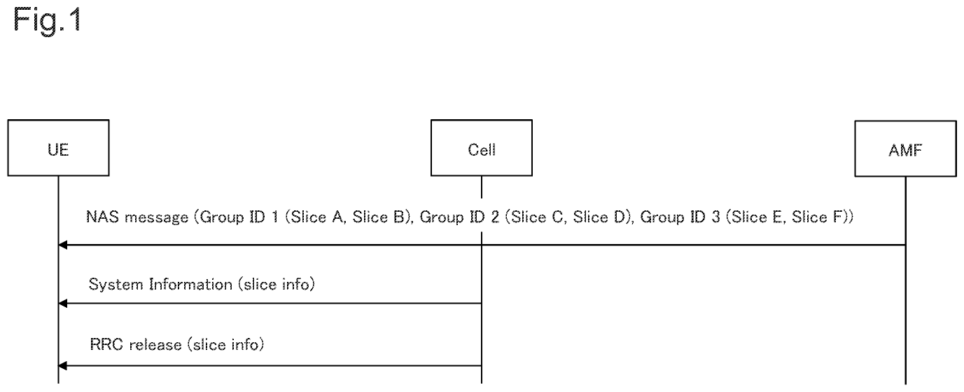

The FIG. 1 illustrates an example of new information available in the User Equipment (UE) for at least one of a cell selection and a cell reselection based on network slice priority.

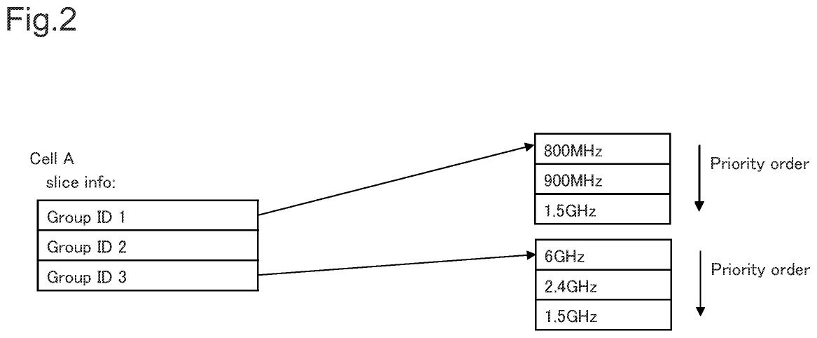

The FIG. 2 explains an example of new slice info that is provided to the UE. Note that this illustration does not show a structure of slice info. The slice info may be called as slice information in this disclosure.

Aspects as shown below disclose a method of a cell selection and cell reselection based on network slice priority and network slice grouping. The aspects enable an external Service Provider to supply and update network slice priority and network slice grouping to the 5GS. The aspects also enable the 5GS to provide the network slice priority and grouping to the UE, to the RAN Node and to other network nodes to facilitate the cell selection and cell reselection based on network slice priority and network slice grouping.

### First Aspect

This disclosure proposes a mechanism that enables at least one of network slices priority information and network slices grouping information are provisioned in the 5G System (5GS) as UE subscription information. This disclosure also proposes a mechanism that enables the UE subscription information is updated by the external service provider(s). The 5GS may be expressed as the UDM but not limited to.

### First Example of the First Aspect

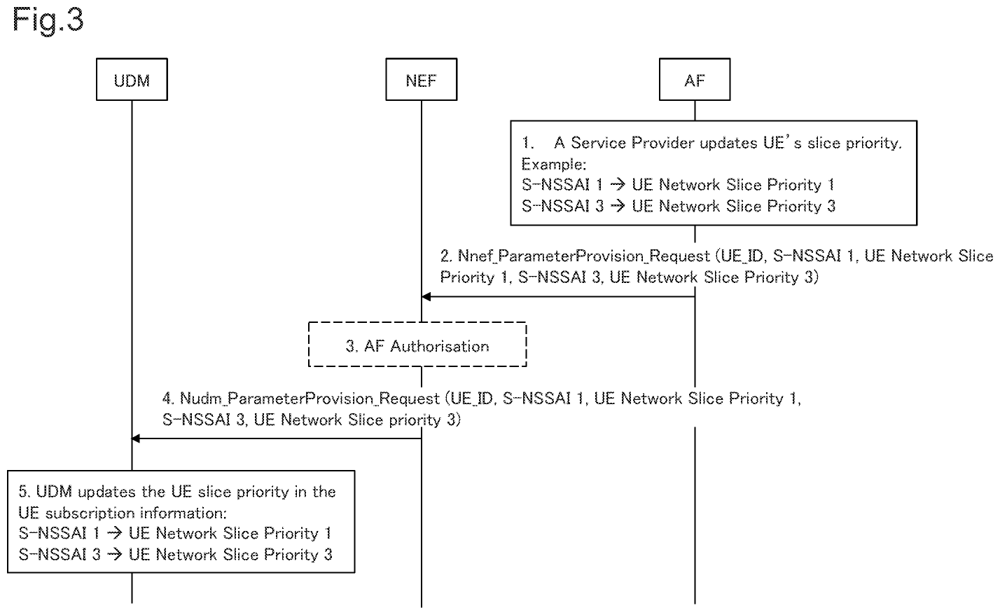

This disclosure in FIG. 3 discloses a mechanism for network slice priority information provisioning to the 5GS and for the network slice priority information updates by external service provider for their customers serviced by the 5G network. The customers may be expressed as mobile terminal users. The UDM may be expressed as a UDM 75. The NEF may be expressed as a NEF 74. The AF may be expressed as an AF 77.

1. A service provider(s) may decide to provision network slice priorities for their users or to update the already provisioned network slice priorities which are to be used by their users or customers for priority-based cell selection and reselection purposes. The provision or update of the network slice priorities may be performed by an Application Function (AF). The AF can be expressed as AF node, AF apparatus, AF device or any other. The network slice priorities may be a list containing a slice priority for each of the slices contained in a list of network slices. The network slice priorities may be included in slice information. For example, the network slice priorities may be expressed as S-NSSAI 1 with UE Network Slice Priority 1 and S-NSSAI 2 with UE Network Slice Priority 3. The network slice priorities may mean a network slice priority. “S-NSSAI 1 with UE Network Slice Priority 1” may mean that UE Network Slice Priority 1 (or a first UE Network Slice Priority) is assigned to S-NSSAI 1. “S-NSSAI 2 with UE Network Slice Priority 3” may mean UE Network Slice Priority 3 (or a third UE Network Slice Priority) is assigned to S-NSSAI 2. The network slice priorities can be called as network slices priorities, network slice priority, UE Network Slice Priority, UE's slice priority, UE slice priority, slice priority, network slice priority information or any other. The priority-based cell selection and reselection may be expressed as to steer the UEs to the network slices based on criteria like, service preference, availability or any other consideration by the service provider(s). The network slice priorities may mean at least one of the network slice priorities.

2. The AF triggers Nnef_ParameterProvision_Request in order to provide the network slice priorities to the Unified Data Management (UDM). The AF sends to the Network Exposure Function (NEF) a Nnef_ParameterProvision_Request message or any other message with the purpose of parameters provisioning to the 5G System in which the AF includes the UE Identity or UE Group identity, one or more network slices with network slice priorities. For example, the UE Identity or UE Group identity may be expressed as UE_ID or UE ID. For example, the one or more network slices with their network slice priorities may be expressed as S-NSSAI 1 with UE Network Slice Priority 1 and S-NSSAI 3 with UE Network Slice Priority 3. For example, the Nnef_ParameterProvision Request message may include UE_ID, S-NSSAI 1, UE Network Slice Priority 1, S-NSSAI 3, and UE Network Slice priority 3. For example, the Nnef_ParameterProvision Request message may include UE_ID, S-NSSAI 1, UE Network Slice Priority 1 assigned to S-NSSAI 1, S-NSSAI 3, and UE Network Slice priority 3 assigned to S-NSSAI 3.

3. The NEF may trigger the AF Authorisation procedure to validate the authenticity of the AF. The NEF can be expressed as NEF node, NEF apparatus, NEF device or any other. The AF can be expressed as the Service Provider.

4. After successful AF Authorisation, the NEF forwards the request from the AF to the UDM via the Nudm ParameterProvision Request message or any other message with the purpose of parameters provisioning to the UDM. For example, the Nudm ParameterProvision Request message may include UE_ID, S-NSSAI 1, UE Network Slice Priority 1, S-NSSAI 3, and UE Network Slice priority 3. For example, the Nudm ParameterProvision Request message may include UE_ID, S-NSSAI 1, UE Network Slice Priority 1 assigned to S-NSSAI 1, S-NSSAI 3, and UE Network Slice priority 3 assigned to S-NSSAI 3. The UDM can be expressed as UDM node, UDM apparatus, UDM device, database or any other. For example, the NEF may forward the request from the AF to the UDM via the Nudm ParameterProvision Request message without the AF Authorisation.

5. If the UDM receives the Nudm ParameterProvision Request message, the UDM stores the newly provisioned or updated UE network slice priorities within the UE's subscription information and the UDM may trigger procedures to update the UE and other network nodes for which the network slice priority update is applicable. If the UDM stores the newly provisioned or updated UE network slice priorities within the UE's subscription information, it may be expressed as the UDM updates the UE's slice priorities in the UE's subscription information. The UE's subscription information may be expressed as UE subscription information, subscription information for the related UE or any other. For example, if the UDM receives the Nudm ParameterProvision Request message, the UDM stores the newly provisioned or updated UE network slice priorities within the subscription information for the UE identified by received UE_ID, and the UDM may trigger procedures to update the UE and other network nodes for which the network slice priority update is applicable. For example, if the UDM receives the Nudm ParameterProvision Request message including UE_ID 1 which identifies UE 1, S-NSSAI 1 associated with UE Network Slice Priority 1 and S-NSSAI 3 associated with UE Network Slice priority 3, the UDM associates S-NSSAI 1 with UE Network Slice Priority 1 and associates S-NSSAI 3 with UE Network Slice Priority 3 and stores the UE network slice priorities within the subscription information for the UE 1. For example, if the UDM receives the Nudm ParameterProvision Request message including UE_ID 1 which identifies UE 1 and S-NSSAI 1 associated with UE Network Slice Priority 1 and S-NSSAI 3 associated with UE Network Slice priority 3 and the UDM has already the subscription information for the UE 1, the UDM associates S-NSSAI 1 with UE Network Slice Priority 1 and associates S-NSSAI 3 with UE Network Slice Priority 3, and updates the UE network slice priorities within the subscription information for the UE 1 by the newly provisioned UE network slice priorities.

### Variant 1 of First Example of the First Aspect

With respect to the network slice priorities, instead of a list of one or more S-NSSAI(s) (or a list of one or more network slice(s)) with their priority in step 2, the AF may provide the network slices in groups where each group contains network slices that have similarities based on criteria like, similar priority, similar service, similar technology, similar capability or any other criteria for creating a group of one or more network slices. For example, the AF may provide Network Slice group 1 which includes S-NSSAI 1 and S-NSSAI 3 with UE Network Slice Group Priority 1, and Network Slice group 2 which includes S-NSSAI 2 and S-NSSAI 4 with UE Network Slice Group Priority 2. These network slice groups would have unique group identity and a relative priority between them. The AF provides these network slice groups related to one UE or a group of UEs via the NEF to the UDM, and the UDM stores the network slice groups in the subscription information for the related UE(s).

### Variant 2 of First Example of the First Aspect

In step 2 the AF may include network slice priority validity or network slice group priority validity in the Nnef_ParameterProvision_Request message in order to define for how long the provided network slice priority or the provided network slice group priority is valid for. The network slice priority validity or the network slice group priority validity may indicate that the network slice priority or the network slice group priority can be valid until update of the network slice priority and network slice group priority. The network slice priority validity or the network slice group priority validity may indicate the time restricted, e.g., valid for days, for weeks or for months after which the network slice priority or network slice group priority can fall to a default network slice priority or default network slice group priority. The network slice priority validity and the network slice group priority validity are stored in the UDM at step 5, and they are valid until the network slice priority or the network slice group priority is updated or is expired. The network slice priority validity and the network slice group priority validity may be forwarded to the UE or UE group members. At network slice priority validity or network slice group priority validity expiration, the UDM may update the network slice priority or the network slice group priority and indicate the UE or the other network nodes for which the network slice priority or the network slice group priority apply with the new network slice priority and the new network slice group priority, e.g., default network slice priority or default network slice group priority. The default network slice priority may be expressed as a default value of the network slice priority. The default network slice group priority may be expressed as a default valued of the network slice group priority.

### Variant 3 of First Example of the First Aspect

In step 2 the AF may include network slice priority validity or network slice group priority validity in the Nnef_ParameterProvision_Request message in order to define for specific location the provided network slice priority or the provided network slice group priority is valid for. The network slice priority validity or the network slice group priority validity may indicate the network slice priority or the network slice group priority can be valid in the designated location, e.g., valid for TAI(s), cell(s), PLMN ID(s), RAT, geographical location as expressed by NPL 3. When the UE leaves the designated location indicated by the network slice priority validity or the network slice group priority validity, the network slice priority or the network slice group priority can fall to a default network slice priority or a default network slice group priority. The network slice priority validity and the network slice group priority validity are stored in the UDM at step 5 and forwarded to the UE or UE group members.

### Variant 4 of First Example of the First Aspect

In step 2 the AF may include network slice priority validity or network slice group priority validity in the Nnef_ParameterProvision_Request message in order to define for specific access type(s) or access RAT type(s) the provided network slice priority or the provided network slice group priority is valid for. The network slice priority or the network slice group priority can be valid with the specified access type or access RAT type, e.g., 3GPP access, non-3GPP access for access type, NR, EUTRA, NBIOT, LTE-M, NR_U, WLAN, VIRTUAL, TRUSTED_N3GA, TRUSTED_WLAN, WIRELINE, WIRELINE_CABLE, WIRELINE_BBF for RAT type as defined in NPL 4. The network slice priority validity and the network slice group priority validity are stored in the UDM at step 5 and forwarded to the UE or group members.

Note that the network slice priority validity or the network slice group priority validity in Variant 2, Variant 3 and Variant 4 of the first Example can be independent from each other and can be selectively combined.

### Second Aspect

This disclosure proposes a mechanism that enables at least one of the network slices priority information and network slices grouping information from the UE subscription information in the UDM are provided to the UE. This disclosure also proposes a mechanism that enables updates to at least one of the network slice priority information and the network slice grouping information in the UDM trigger updates to the UE. In some examples, the UE may be expressed as a UE 3. The RAN node may be expressed as a (R)AN node 5. The AMF may be expressed as an AMF 70. The PCF may be expressed as a PCF 73. The UDM may be expressed as a UDM 75.

### First Example of the Second Aspect

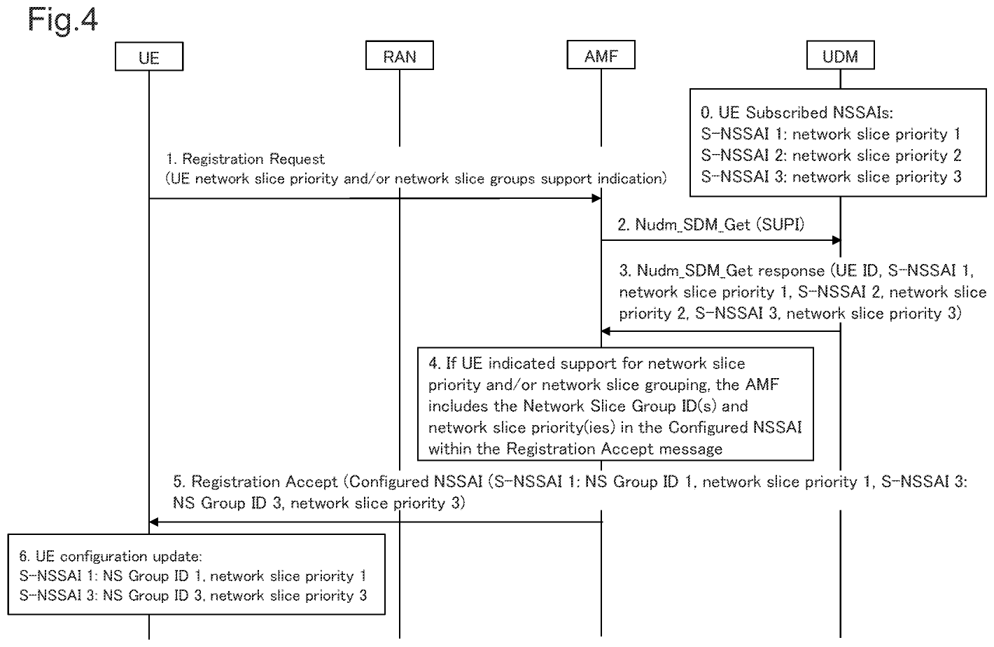

This disclosure in FIG. 4 discloses a mechanism for network slice priority information provisioning and further updates to the UE during a UE Registration procedure.

0. The UDM holds the UE subscription information, including the UE subscribed network slices and their priorities. For example, S-NSSAI 1 is associated with network slice priority 1, S-NSSAI 2 is associated with network slice priority 2 and S-NSSAI 3 is associated with network slice priority 3. For example, the UDM stores S-NSSAI 1 associated with network slice priority 1, S-NSSAI 2 associated with network slice priority 2 and S-NSSAI 3 associated with network slice priority 3 as the UE subscribed network slices and their priorities. For example, the UDM may receive the UE subscribed network slices and their priorities from the AF by processes in the first Aspect.

1. A UE triggers a registration procedure and if the UE supports at least one of the network slice priority feature and the network slice grouping feature, the UE indicates that the UE supports at least one of the network slice priority feature and the network slice grouping feature in the Registration Request message or in any other NAS message. For example, in a case where the UE can recognize or understand the network slices along with their network slice priorities described below and the network slice groups described below, the UE supports at least one of the network slice priority feature and the network slice grouping feature.

2. If the AMF does not have UE subscription information for the UE, the AMF sends Nudm_SDM_Get message to the UDM in order to fetch the UE subscription information. A case where the AMF does not have UE subscription information for the UE may be a case of an initial registration. The AMF includes a UE identity, for example SUPI for the UE, in the Nudm_SDM_Get message. The AMF may include in the Nudm_SDM_Get message a Requested NSSAI which is received from the UE in the Registration Request message. The Requested NSSAI may indicate network slices which the UE is asking to register for.

3. The UDM answers the AMF with Nudm_SDM_Get response message in which the UDM includes the UE subscription information. The UE subscription information may include the network slices the UE is asking to register for and the UE is subscribed for and their network slice priority. The UE subscription information may include all network slices which the UDM stores. For example, if the UE is subscribed to S-NSSAI 1 with network slice priority 1 and S-NSSAI 3 with network slice priority 3, and the UE is asking to register for S-NSSAI 1, S-NSSAI 2 and S-NSSAI3, the UDM may send the Nudm_SDM_Get response message including UE_ID for the UE, S-NSSAI 1, UE Network Slice Priority 1 assigned to S-NSSAI 1, S-NSSAI 2, UE Network Slice priority 2 assigned to S-NSSAI 2, S-NSSAI 3, and UE Network Slice priority 3 assigned to S-NSSAI 3. The UE ID for the UE may be expressed as the SUPI or the UE.

4. If the UE indicated support for network slice priority in the Registration Request message or in any other NAS message, the AMF includes in the Configured NSSAI or in the Allowed NSSAI the network slices that the UE requested and the UE is subscribed to along with their network slice priorities. If the UE has also indicated support for network slice grouping, the AMF may group the network slices in network slice groups where each of the network slice groups can be identified with unique network slice group id and each network slice group may include one or more network slices. The AMF may include in the Configured NSSAI or in the Allowed NSSAI the network slice group id(s) associated with the network slices that the UE requested and the UE is subscribed to along with their network slice priorities. The network slice group id(s) may be expressed as Network Slice Group ID(s) or NS Group ID(s) or group id(s). The network slices in the group may be listed in priority order. “id” may mean identity or identifier. The AMF may use different criteria when grouping the network slices in network slice groups. The AMF may use criteria standardised or operator defined. Some examples of the different criteria are shown below:
a criteria based on the network slice priority—For example, network slices with same or similar priority may be part of the same network slice group; or
a criteria based on the service provided by the network slices—For example, network slices that can provide same or similar services may be part of the same network slice group, the network slices that can provide same or similar services may be expressed as the network slices with the same Slice Service Type (SST).; or
a criteria based on the network slice ownership—For example, network slices belonging to the same operator or belonging to equivalent PLMNs may be grouped in the same network slice group, the network slices belonging to the same operator may be expressed as the network slices with same Slice Differentiator (SD).; or
any other criteria for network slice grouping.

5. The AMF provides the network slices along with their network slice priorities and the network slice groups, each of the network slice groups identified by unique network slice group id, to the UE within the Configured NSSAI or Allowed NSSAI or as separate parameters within the Registration Accept message or within any other NAS message from the AMF to the UE. When the UE receives network slice priorities and network slice groups, the UE sends the Registration complete message to acknowledge the reception of the network slice priorities or the network slice groups. The network slice group may be expressed as a NS group. The network slice group id may be expressed as a NS group ID. For example, in a case where the UE requests S-NSSAI 1, S-NSSAI 2 and S-NSSAI 3 in the Registration Request and the UE is subscribed to S-NSSAI 1 and S-NSSAI 3, the AMF provides S-NSSAI 1 along with network slice priority 1 and S-NSSAI 3 along with network slice priority 3. The UE requesting S-NSSAI 1, S-NSSAI 2 and S-NSSAI 3 in the Registration Request may be expressed as the UE including S-NSSAI 1, S-NSSAI 2 and S-NSSAI 3 in the Requested NSSAI. For example, in a case where the UE requests S-NSSAI 1, S-NSSAI 2 and S-NSSAI 3 in the Registration Request and the UE is subscribed to S-NSSAI 1 and S-NSSAI 3, the AMF makes network slice group 1 including S-NSSAI 1 and network slice group 3 including S-NSSAI 3. The AMF assigns network slice group id 1 to the network slice group 1 and assigns network slice group id 3 to the network slice group 3. The AMF provides the network slice group 1 including S-NSSAI 1 along with network slice priority 1 and the network slice group 3 including S-NSSAI 3 along with network slice priority 3. For example, the AMF may provide to the UE information indicating that network slice priority 1 is assigned to S-NSSAI 1 and information indicating that network slice priority 3 is assigned to S-NSSAI 3. For example, the AMF may provide to the UE information indicating that S-NSSAI 1 is included in the network slice group 1 which is identified by network slice group id 1 and that network slice priority 1 is assigned to S-NSSAI 1 and information indicating that S-NSSAI 3 is included in the network slice group 3 which is identified by network slice group id 3 and that network slice priority 3 is assigned to S-NSSAI 3. The AMF may provide the network slices along with their network slice priorities without the network slice groups.

6. In a case where the UE receives the Registration Accept message, the UE may update UE configuration. Updating the UE configuration may be expressed as UE configuration update(s) or storing network slice(s) along with its priority(ies) and associated NS Group ID, if available, and applying the updated UE configuration. The UE stores the network slices provided by the network along with their network slice priorities and the network slice groups. The UE may store the network slices along with their network slice priorities in a case where the AMF provides the network slices along with their network slice priorities without the network slice groups. The network may be expressed as the AMF. The UE may utilise at least one of the network slice priority and the grouping information for service improvement and resource optimisation purposes. The grouping information may be expressed as information indicating the network slice group(s). For example, the UE uses at least one of the network slice priority and the grouping information for processes as shown below:
Cell selection and cell reselection based on network slice priority or network slice group—for example, when the UE is selecting a cell or reselecting a new cell, the UE may consider the network slices that the candidate cells support and the UE may give a priority to a cell supporting the network slice with the highest priority between the network slices the UE has been assigned in the Configured NSSAI or Allowed NSSAI. For example, the UE may select or reselect a cell supporting the network slice with the highest priority between the network slices the UE has been assigned in the Configured NSSAI or Allowed NSSAI.

Alternatively, the UE may trigger cell selection or cell reselection based on higher priority network slices or higher priority network slice groups supported by other cell(s) available to the UE even if the current serving cell is with good signal strength, i.e., even the current cell can continue serving the UE.
Service optimisation—for example, if the UE has multiple services requiring access to the network, the UE may prioritise the service which is on higher priority network slice.

### Variant 1 of First Example of the Second Aspect

If the UDM holds at least one of network slice priority validity, network slice group id, network slice group priority and network slice group priority validity as the UE subscription in step 0, step 3 and step 5 may include at least one of the network slice priority validity and the network slice group priority validity to convey at least one of the network slice priority validity and the network slice group priority validity to the UE. If the UDM holds network slice priority validity in step 0 and the AMF assigns the network slice group priority and network slice group priority validity in step 4, the AMF may include in step 5 at least one of the network slice priority validity and the network slice group priority validity to convey at least one of the network slice priority validity and the network slice group priority validity to the UE. When the UE receives at least one of the network slice priority validity and the network slice group priority validity, the UE applies network slice priority based on at least one of the received network slice priority validity and the received network slice group priority validity. The network slice priority validity and the network slice group priority validity may be same to the network slice priority validity and the network slice group priority validity in Variants 2, 3 and 4 of the first Example of the first Aspect.

For example, the network slice priority validity may indicate at least one time period when the network slice priority is valid and a location where the network slice priority is valid and an access type or an access RAT type for which the network slice priority is valid. The location may be expressed as TAI(s), cell(s), PLMN ID(s), RAT, or geographical location as expressed by NPL 3.

For example, the network slice group priority validity may indicate at least one time period when the network slice group priority is valid and a location where the network slice group priority is valid and an access type or an access RAT type for which the network slice group priority is valid. The location may be expressed as TAI(s), cell(s), PLMN ID(s), RAT, or geographical location as expressed by NPL 3.

For example, in a case where the period indicated by the network slice priority validity is expired, the UE may update the network slice priority to the default network slice priority. For example, in a case where the period indicated by the network slice group priority validity is expired, the UE may update the network slice group priority to the default network slice group priority.

For example, in a case where the UE leaves the location indicated by the network slice priority validity, the UE may update the network slice priority to the default network slice priority. For example, in a case where the UE leaves the location indicated by the network slice group priority validity, the UE may update the network slice group priority to the default network slice group priority.

For example, in a case where the UE changes at least one of the access type and the access RAT type indicated by the network slice priority validity, the UE may update the network slice priority to the default network slice priority. For example, in a case where the UE changes at least one of the access type and the access RAT type indicated by the network slice group priority validity, the UE may update the network slice group priority to the default network slice group priority.

The Registration Accept also includes list of one or more tracking areas where the NS Group ID is valid in a registration area or an indication whether the NS group ID is valid in the registration area. The Registration Accept may also include list of one or more tracking areas where the NS Group ID is valid in a registration area or an indication whether the NS group ID is valid in the registration area. Another indication may be sent to indicate whether the NS group ID is valid in the serving PLMN or all the PLMNs in the registration area in a case where a registration area includes the Tracking Areas (TAs) belonging to different PLMN. The serving PLMN may be indicated by the MCC and MNC of the GU AMI of allocated 5G-GUTI. There can be another indication whether the NS group ID is applicable to all PLMN in the equivalent PLMN list. These indications may be sent to the UE. For example, these indications may indicate whether network slice(s) in the group identified by the NS group ID is valid or not. For example, the UE may determine whether at least one of the network slice priority and the network slice group priority is valid or not by using these indications. For example, the UE may determine whether at least one of the network slice priority and the network slice group priority is valid or not in a location or PLMN indicated by these indications. The location may mean a registration area or a tracking area. The PLMN may mean a serving PLMN.

### Second Example of the Second Aspect

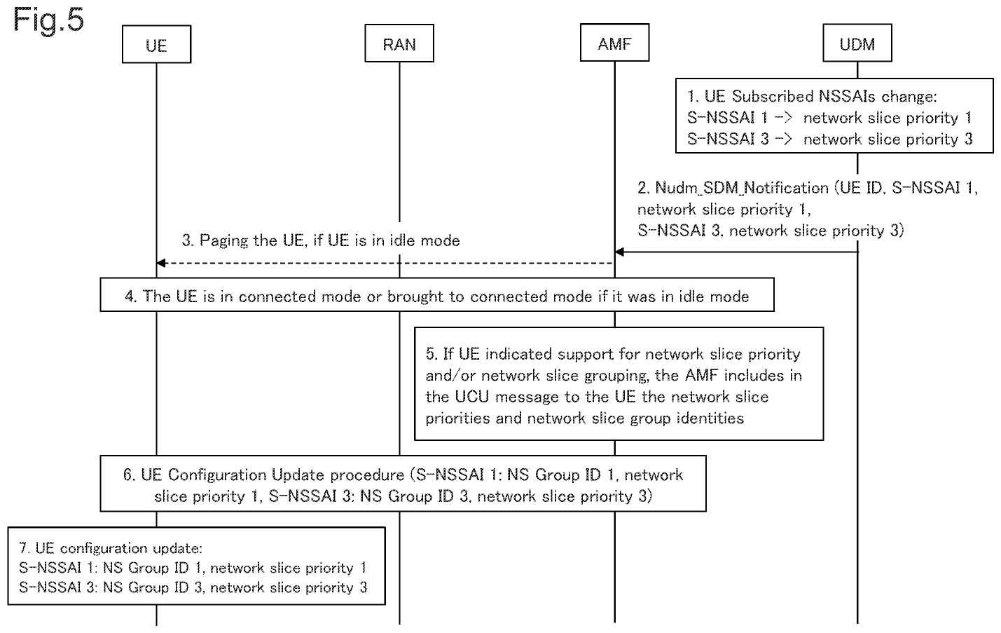

This disclosure in FIG. 5 discloses a mechanism for network slice priority information provisioning and further updates to the UE during a UE Configuration Update procedure.

1. The UE subscribed network slice priority information in the UDM may be updated by the operator or by the service provider via the NEF. The UE subscribed network slice priority information in the UDM may be updated by processes in the first Aspect. For example, UE subscribed S-NSSAI 1 becomes of network slice priority 1 and the UE Subscribed S-NSSAI 3 becomes of network slice priority 3. For example, network slice priority 1 is assigned to UE subscribed S-NSSAI 1 and network slice priority 3 is assigned to the S-NSSAI 3.

2. When the network slice priority (or the network slice priorities) is changed in the UDM, the UDM triggers Nudm_SDM_Notification message (or any other message with the purpose of indicating a change in the UE subscription information) including UE ID, S-NSSAI 1, network slice priority 1, S-NSSAI 3 and network slice priority 3 to the AMF to update the UE context within the AMF with the new network slice priorities, for example for S-NSSAI 1 with the updated network slice priority 1 and for the S-NSSAI 3 with the updated network slice priority 3. For example, the UDM sends Nudm_SDM_Notification message including S-NSSAI 1 along with network slice priority 1 and S-NSSAI 3 along with network slice priority 3 to the AMF.

3. If the UE for which the network slice priority was updated is in idle mode, the AMF may page the UE to bring the UE in connected mode.

4. The UE is in connected mode, or if the UE was paged in step 3, the UE is brought in connected mode.

5. If the UE supports network slice priority (or network slice priority feature), the AMF includes in a UE Configuration Update (UCU) message to the UE (or in any other NAS message from the AMF to the UE) the network slices which network slice priorities have been changed along with their new network slice priorities. The UE supporting network slice priority (or network slice priority feature) may mean the UE has indicated support for network slice priority (or network slice priority feature) in the Registration Request message when registering to the network or in any other NAS messages. If the UE has also indicated support for network slice grouping (or network slice grouping feature), the AMF may group the network slices in network slice groups where each of the network slice groups can be identified with unique network slice group id and each network slice group may include one or more network slices. The UE supporting network slice grouping (or network slice grouping feature) may mean the UE has indicated support for network slice grouping (or network slice grouping feature) in the Registration Request message when registering to the network or in any other NAS messages. The network slices in the network slice group may be listed in priority order. The AMF may use different criteria when grouping the network slices in network slice groups. The AMF may use criteria standardised or operator defined. Examples of the different criteria are shown below:
a criteria based on the network slice priority—For example, network slices with same or similar priority may be part of the same network slice group.; or
a criteria based on the service provided by the network slices—For example, network slices that can provide same or similar services may be part of the same network slice group, the network slices that can provide same or similar services may be expressed as the network slices with the same Slice Service Type (SST).; or
a criteria based on the network slice ownership—For example, network slices belonging to the same operator or belonging to equivalent PLMNs may be grouped in the same network slice group, the network slices belonging to the same operator may be expressed as the network slices with same Slice Differentiator (SD).; or
any other criteria for network slice grouping.

For example, in a case where the UE can recognize or understand the network slices along with their network slice priorities described below and the network slice groups described below, the UE supports at least one of the network slice priority and the network slice grouping.

6. The AMF provides the updated network slices along with their updated network slice priority and the network slice groups, each of the network slice groups identified by unique network slice group id to the UE within the UE Configuration Update message. The AMF may provide the network slices along with their network slice priorities without the network slice groups.

For example, in a case where the UE has indicated support for network slice priority, the AMF sends a UE Configuration Update (UCU) message including S-NSSAI 1 along with network slice priority 1 and S-NSSAI 3 along with network slice priority 3.

For example, in a case where the UE has indicated support for network slice priority and support for network slice grouping, the AMF makes network slice group 1 including S-NSSAI 1 and network slice group 3 including S-NSSAI 3. And the AMF assigns network slice group id 1 to the network slice group 1 and assigns network slice group id 3 to the network slice group 3. Then the AMF sends a UE Configuration Update (UCU) message which includes the network slice group 1 including S-NSSAI 1 along with network slice priority 1 and the network slice group 3 including S-NSSAI 3 along with network slice priority 3. The AMF may include network slice group id 1 and network slice group id 3 in the UCU message.

For example, the AMF may provide, to the UE, information indicating that network slice priority 1 is assigned to S-NSSAI 1, and information indicating that network slice priority 3 is assigned to S-NSSAI 3. For example, the AMF may provide, to the UE, information indicating that S-NSSAI 1 is included in the network slice group 1 which is identified by network slice group id 1 and that network slice priority 1 is assigned to S-NSSAI 1, and information indicating that S-NSSAI 3 is included in the network slice group 3 which is identified by network slice group id 3 and that network slice priority 3 is assigned to S-NSSAI 3.

7. In a case where the UE receives the UE Configuration Update message, the UE may update UE configuration. Updating the UE configuration may be expressed as UE configuration update(s) or storing network slice(s) along with its new priority(ies) and associated NS Group ID, if available, and applying the updated UE configuration. The UE stores the network slices provided by the network along with their network slice priorities and the network slice groups. The network may be expressed as the AMF. The UE may store the network slices along with their network slice priorities in a case where the AMF provides the network slices along with their network slice priorities without the network slice groups. The UE may utilise at least one of the network slice priority and the grouping information for service improvement and resource optimisation purposes. The grouping information may be expressed as information indicating the network slice group(s). For example the UE uses at least one of the network slice priority and the grouping information for processes as shown below:
Cell selection and cell reselection based on network slice priority or network slice group—for example, when the UE is selecting a cell or reselecting to a new cell, the UE may consider the network slices that the candidate cells support and the UE may give a priority to a cell supporting the network slice with the highest priority between the network slices the UE has been assigned in the Configured NSSAI or Allowed NSSAI. For example, the UE may select or reselect a cell supporting the network slice with the highest priority between the network slices the UE has been assigned in the Configured NSSAI or Allowed NSSAI.

Alternatively, the UE may trigger cell selection or cell reselection based on higher priority network slices or higher priority network slice groups supported by other cell(s) available to the UE even if the current serving cell is with good signal strength, i.e., even the current cell can continue serving the UE.
Service optimisation—for example, if the UE has multiple services requiring access to the network, the UE may prioritise the service that is on higher priority network slice.

### Variant 1 of Second Example of the Second Aspect

If the UDM holds at least one of network slice priority validity, network slice group id, network slice group priority and network slice group priority validity as the UE subscription, and at least one of the network slice priority validity and the network slice group priority validity is changed in step 1, step 2 and step 6 include at least one of the network slice priority validity and the network slice group priority validity to convey at least one of the network slice priority validity and the network slice group priority validity to the UE. If the UDM holds network slice priority validity in step 0 and the AMF assigns the network slice group priority and network slice group priority validity in step 5, the AMF may include in step 6 at least one of the network slice priority validity and the network slice group priority validity to convey at least one of the network slice priority validity and the network slice group priority validity to the UE. When the UE receives at least one of the network slice priority validity and the network slice group priority validity, the UE applies network slice priority based on at least one of the received network slice priority validity and the received network slice group priority validity. The network slice priority validity and the network slice group priority validity may be same to the network slice priority validity and the network slice group priority validity in Variants 2, 3 and 4 of the first Example of the first Aspect. The UE may use at least one of the received network slice priority validity and the received network slice group priority validity in the same manner as Variant 1 of First Example of the Second Aspect.

The UE Configuration Update (UCU) message also includes list of one or more tracking areas where the NS Group ID is valid in a registration area or an indication whether the NS group ID is valid in the registration area. The UE Configuration Update (UCU) message may also include list of one or more tracking areas where the NS Group ID is valid in a registration area or an indication whether the NS group ID is valid in the registration area. Another indication may be sent to indicate whether the NS group ID is valid in the serving PLMN (the MCC and MNC of the GU AMI of allocated 5G-GUTI) or all the PLMNs in the registration area in a case where a registration area includes the Tracking Areas (TAs) belonging to different PLMN. There can be another indication whether the NS group ID is applicable to all PLMN in the equivalent PLMN list. These indications may be sent to the UE. For example, these indications may indicate whether network slice(s) in the group identified by the NS group ID is valid or not. For example, the UE may determine whether at least one of the network slice priority and the network slice group priority is valid or not by using these indications. For example, the UE may determine whether at least one of the network slice priority and the network slice group priority is valid or not in a location or PLMN indicated by these indications. The location may be expressed as a registration area or a tracking area. The PLMN may be expressed as a serving PLMN. The UE stores the validity parameter for each network slice priority and the validity for each network slice group priority along with each network slice priority and network slice group priority and the UE runs timers for each network slice and network slice group with a value equal to the validity parameter of each network slices priority and network slice group priority. The UE uses the stored network slice priority and the stored network slice group priority for the purposes of cell selection and reselection as per the description in step 7 of the Second example of the Second Aspect until the expiry of the priority validity timer for each of the network slices and network slice groups or until the next update to priority validity by the network for a network slice or a network slice group. At expiry of one or more network slice priority validity timers or network slice group priority validity timers or at update to the network slice priority validity or network slice group priority validity by the network, the UE restarts the network slice priority or network slice group priority validity timers if updated by the network for example or the UE sets the network slice priority and the network slice group priorities to a default priorities if the validity timer expires and not updated by the network.

### Third Example of the Second Aspect

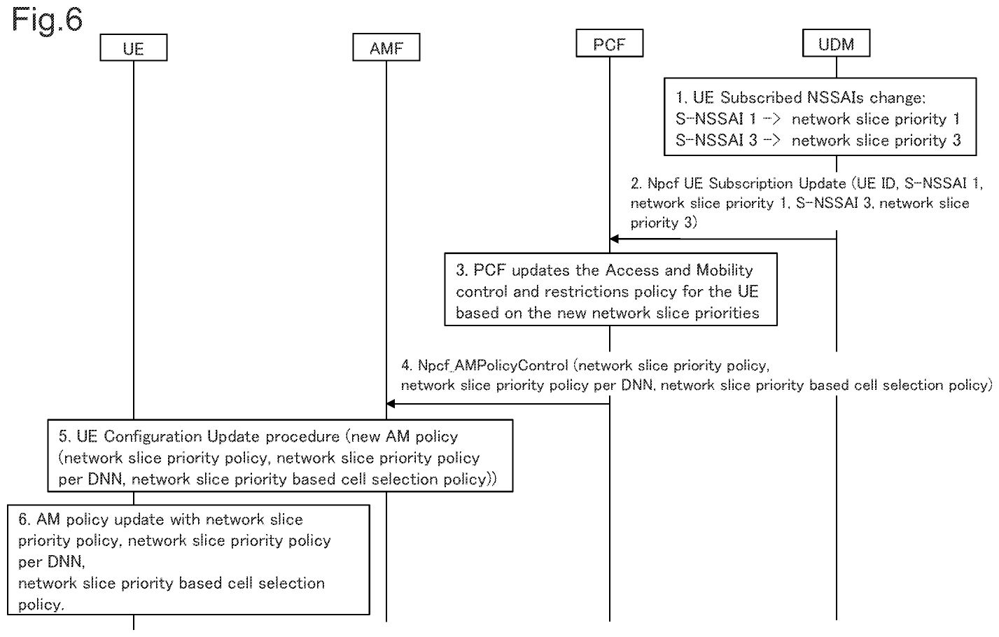

This disclosure in FIG. 6 discloses a mechanism for Access and Mobility Policy rules and restrictions update in an AMF and a UE.

1. The UE subscribed network slice priority information in the UDM may be updated by the operator or by the service provider via the NEF. The UE subscribed network slice priority information in the UDM may be updated by processes in the first Aspect. For example, UE subscribed S-NSSAI 1 becomes of network slice priority 1 and the UE Subscribed S-NSSAI 3 becomes of network slice priority 3. For example, network slice priority 1 is assigned to UE subscribed S-NSSAI 1 and network slice priority 3 is assigned to the S-NSSAI 3.

2. When the network slice priority (or the network slice priorities) is changed in the UDM, the UDM triggers Npcf UE Subscription Update message (or any other message with the purpose of indicating a change in the UE subscription information) including UE ID, S-NSSAI 1, network slice priority 1, S-NSSAI 3 and network slice priority 3 to the PCF to update the PCC rules or at least one of the URSP rule and NSSP rule for the UE within the PCF with the new network slice priorities, for example for the UE subscribed S-NSSAI 1 with the updated network slice priority 1 and for the S-NSSAI 3 with the updated network slice priority 3. The AM rules may be expressed as an Access and Mobility (AM) policy, and at least one of the URSP rule and the NSSP rule may be expressed as UE Policy. For example, the UDM sends Npcf UE Subscription Update message including UE ID for the UE, S-NSSAI 1 along with network slice priority 1 and S-NSSAI 3 along with network slice priority 3 to the PCF.

3. The PCF updates an Access and Mobility (AM) policy for the UE or for the group of UEs for which the network slice priorities have changed. The AM policy may be expressed as AM rules and restrictions, or AM policy rules, or Access and Mobility control and restrictions policy or AM restrictions. It is proposed that the following new AM rules and restrictions are defined that depend on the network slice priority:
Network slice priority rule—the network slice priority rule defines the relative network slice priority for a UE. The granularity of this rule could be per TA or per PLMN;
Network slice priority rule per DNN—the network slice priority rule per DNN defines the relative network slice priority for a UE for network slices supported by certain DNN. The granularity of this rule could be per TA or per PLMN;
Network slice priority based cell selection—the network slice priority based cell selection rule defines the relative network slice priority for cell selection purpose by the UE. The granularity of this rule could be per TA or per PLMN.
Network slice registration rule—the network slice registration rule defines the network slices the UE is suggested to register for. The network may control the UE registration(s) and more specifically the network slices which the UE requests to register for and when the UE registers for these network slices based on the AM policy. The network slices which the UE requests to register for may mean the network slices the UE includes in the Requested NSSAI. The network may assist the UE via the AM policy update with a list of network slices the UE is recommended to register with, for example, network slices listed in network slice priority order, in order to help the UE in deciding for which network slices to request registration by updating the AM Policy with information to help the UE to register for network slices which are likely to be supported in UE location. The network may use the current AM restrictions and the UE mobility statistics and predictions like the expected UE mobility and expected UE moving trajectory provided by the NWDAF or by the service provider. For example, the network may use the current AM restrictions and the UE mobility statistics and predictions like the expected UE mobility and expected UE moving trajectory provided by the NWDAF or by the service provider for controlling the UE registration(s) or helping the UE in deciding for which network slices to request registration.

For example, the PCF makes or updates the AM policy rule(s) related to S-NSSAI 1 and S-NSSAI 3 based on the updated network slice priority 1 and the updated network slice priority 3. The AM policy rule(s) may be expressed as at least one of Network slice priority rule, Network slice priority rule per DNN and Network slice priority based cell selection. For example, the PCF includes S-NSSAI 1 with the updated network slice priority 1 and S-NSSAI 3 with the updated network slice priority 3 in the AM policy rule(s) for making or updating the AM policy rule(s). For example, in a case where the PCF has information related to at least one of TA(s), PLMN(s) and DNN(s) or obtains the information from other network node(s), the PCF uses the information to make or update the AM policy. For example, the PCF updates the AM policy for the UE identified by the UE ID.

4. The PCF sends, to the AMF, an Npcf_AMPolicyControl message including the new and updated AM policy rule(s). The new and updated AM policy rule(s) may include new AM policy rule(s) made by the PCF. The AMF stores the new and updated AM policy rules in the UE context.

5. The AMF updates the UE with the new and updated AM policy rule(s) via a UE Configuration Update procedure. For example, the AMF sends, to the UE, the new and updated AM policy rule(s) during the UE Configuration Update procedure.

6. In a case where the UE receives the Npcf_AMPolicyControl message, the UE may update UE configuration. Updating the UE configuration may be expressed as UE configuration update(s) or storing new and updated AM policy. The UE stores the new and updated AM policy rule(s) and starts applying the AM policy rule(s). For example, the UE starts applying the AM policy rule(s) as soon as they are received. For example, the UE may use the new and updated AM policy rules for at least one of a cell selection and a cell reselection and service optimisation as described step 7 in Second Example of the Second Aspect.

### Variant 1 of Third Example of the Second Aspect

If the UDM holds at least one of network slice priority validity, network slice group id, network slice group priority and network slice group priority validity as the UE subscription and at least one of the network slice priority validity and the network slice group priority validity is changed in step 1, step 2, step 4 and step 5 include at least one of the network slice priority validity and the network slice group priority validity to convey at least one of the network slice priority validity and the network slice group priority validity to the UE. If the UDM holds network slice priority validity in step 1 and the PCF assigns the network slice group id, the network slice group priority and network slice group priority validity in step 3, the PCF may include in step 3 at least one of the network slice priority validity and the network slice group priority validity to convey at least one of the network slice priority validity and the network slice group priority validity to the UE. If the UDM holds network slice priority validity in step 1 and the AMF assigns the network slice group id, the network slice group priority and network slice group priority validity in step 5, the AMF may include in step 5 at least one of the network slice priority validity and the network slice group priority validity to convey at least one of the network slice priority validity and the network slice group priority validity to the UE. When the UE receives at least one of the network slice priority validity and the network slice group priority validity, the UE applies network slice priority based on at least one of the received network slice priority validity and the received network slice group priority validity. The network slice priority validity and the network slice group priority validity may be same to the network slice priority validity and the network slice group priority validity in Variants 2, 3 and 4 of the first Example of the first Aspect. The UE stores the validity parameter for each network slice priority and the validity for each network slice group priority along with each network slice priority and network slice group priority and the UE runs timers for each network slice and network slice group with a value equal to the validity parameter of each network slices priority and network slice group priority. The UE uses the stored network slice priority and the stored network slice group priority for the purposes of cell selection and reselection as per the description in step 7 of the Second example of the Second Aspect until the expiry of the priority validity timer for each of the network slices and network slice groups or until the next update to priority validity by the network for a network slice or a network slice group. At expiry of one or more network slice priority validity timers or network slice group priority validity timers or at update to the network slice priority validity or network slice group priority validity by the network, the UE restarts the network slice priority or network slice group priority validity timers if updated by the network for example or the UE sets the network slice priority and the network slice group priorities to a default priorities if the validity timer expires and not updated by the network. The network slice priority(ies) may be grouped in network slice group(s), and the network slice group(s) may be sent to associated node(s). The associated node(s) may be expressed as at least one of the PCF and the AMF and the UE. In this case, the network slice group may be identified with unique network slice group id and each network slice group may include one or more network slices. The network slices in the network slice group may be listed in priority order. The grouping may be performed by the UDM or the PCF or the AMF. When grouping the network slices in the network slice group(s), at least one of the criteria as mentioned in Variant 1 of First Example of the First Aspect or First Example of the Second Aspect may be used. The UE may use at least one of the received network slice priority validity and the received network slice group priority validity in the same manner as Variant 1 of First Example of the Second Aspect.

### Fourth Example of the Second Aspect

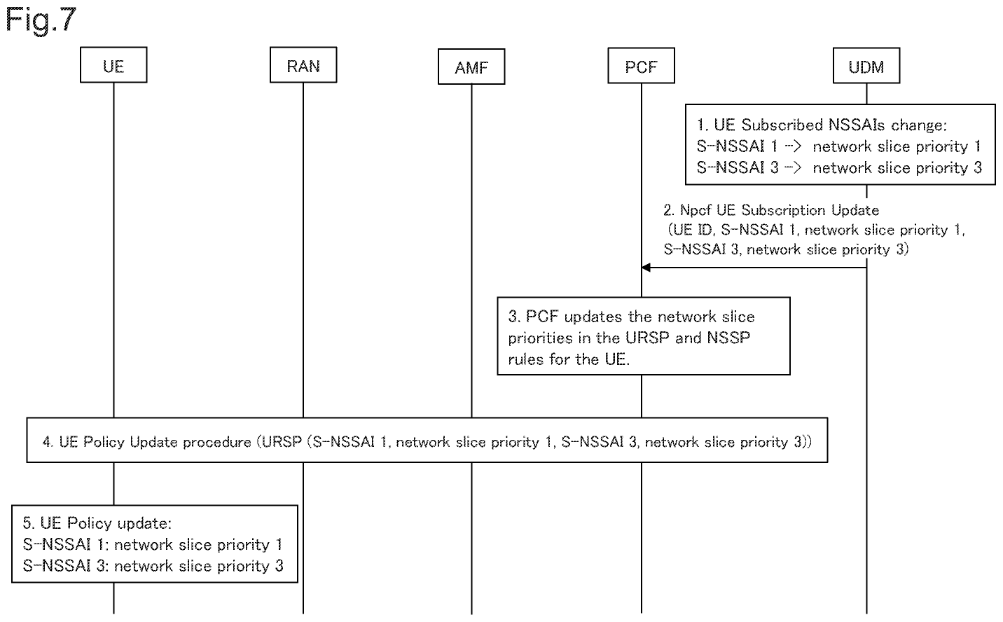

This disclosure in FIG. 7 discloses a mechanism for UE Policy update in a PCF and in a UE based on the network slice priorities change.

1. The UE subscribed network slice priority information in the UDM may be updated by the operator or by the service provider via the NEF. The UE subscribed network slice priority information in the UDM may be updated by processes in the first Aspect. For example, UE subscribed S-NSSAI 1 becomes of network slice priority 1 and the S-NSSAI 3 becomes of network slice priority 3. For example, network slice priority 1 is assigned to UE subscribed S-NSSAI 1 and network slice priority 3 is assigned to the S-NSSAI 3.

2. When the network slice priority (or the network slice priorities) is changed in the UDM, the UDM triggers Npcf UE Subscription Update message (or any other message with the purpose of indicating a change in the UE subscription information) including UE ID, S-NSSAI 1, network slice priority 1, S-NSSAI 3 and network slice priority 3 to the PCF to update at least one of a URSP rule and a NSSP rule for the UE within the PCF with the new network slice priorities, for example for the UE subscribed S-NSSAI 1 with the updated network slice priority 1 and for the S-NSSAI 3 with the updated network slice priority 3. For example, the UDM sends Npcf UE Subscription Update message including UE ID for the UE, S-NSSAI 1 along with network slice priority 1 and S-NSSAI 3 along with network slice priority 3 to the PCF.

3. The PCF updates the network slice priorities in at least one of the URSP rule and NSSP rule for that UE based on the updated network slice priority (or based on the updated network slice priorities). For example, the PCF updates slice priorities related to S-NSSAI 1 and S-NSSAI 3 in at least one of the URSP rule and the NSSP rule by using the updated network slice priority 1 and the updated network slice priority 3. For example, the PCF may add the updated network slice priority 1 for the S-NSSAI 1 and the updated network slice priority 3 for the S-NSSAI 3 to the at least one of the URSP rule and the NSSP rule.

4. The PCF sends, to the UE, at least one of the updated URSP rule and the updated NSSP rule during the UE Policy Update procedure. The UE Policy Update procedure may mean a procedure for updating a UE policy.

5. In a case where the UE receives at least one of the updated URSP rule and the updated NSSP rule during the UE Policy Update procedure, the UE may update UE Policy. Updating the UE Policy may be expressed as UE Policy update(s) or storing at least one of the updated URSP rule and the updated NSSP rule. The UE stores the updated UE Policy rules and applies the updates rules and the updated network slice priorities when mapping applications to network slices and PDU sessions routing considering the latest network slice priorities. The UE Policy may include at least one of the updated URSP rule and the updated NSSP rule. The updated UE Policy rules may be expressed as the updated PCC rules, the updated URSP and NSSP policies etc. For example, the UE updates the UE Policy rules based on at least one of the received updated URSP policy and NSSP policy. The at least one of the received updated URSP policy and NSSP policy may be expressed as at least one of the updated URSP rule and the updated NSSP rule. For example, if in the Network Slice Selection rule including multiple network slices and the multiple network slices are listed, the network slices are listed in priority order based on the network slice priorities in the UE subscription. For example, the UE may sort multiple network slices of the Network Slice Selection rule in priority order based on the updated network slice priority. For different UEs the priority order can be different based on the UE subscribed network slice priorities. For example, the UE may use the updated UE Policy rules for at least one of a cell selection and a cell reselection and service optimisation as described step 6 in First Example of the Second Aspect. Also, via the UE Policy and URSP rules update in the UE by the network, the UE may use the UE Policy and URSP rules updates in deciding for which network slices to register for and for how long the UE to hold the registration for these network slice and for which network slices the UE to deregister from based on the active or running applications on the UE, based on the network slice priorities or based on any other consideration by the network like operator policy, for example. Via the UE Policy and URSP rules update in the UE by the network, the UE may also use the UE Policy and URSP rules updates in deciding on which network slices to request services e.g., trigger PDU Sessions or release PDU Sessions, or transfer PDU sessions between network slices based again on the active or running applications on the UE, based on the network slice priorities or based on any other consideration by the network like the operator policy, for example.

### Variant 1 of Fourth Example of the Second Aspect

If the UDM holds at least one of network slice priority validity, network slice group id, network slice group priority and network slice group priority validity as the UE subscription and at least one of the network slice priority validity and the network slice group priority validity is changed in step 1, step 2 and step 4 include at least one of the network slice priority validity and the network slice group priority validity to convey at least one of the network slice priority validity and the network slice group priority validity to the UE. If the UDM holds network slice priority validity in step 1 and the PCF assigns the network slice group id, the network slice group priority and network slice group priority validity in step 3, the PCF may include in step 3 at least one of the network slice priority validity and the network slice group priority validity to convey at least one of the network slice priority validity and the network slice group priority validity to the UE. When the UE receives at least one of the network slice priority validity and the network slice group priority validity, the UE applies network slice priority based on at least one of the received network slice priority validity and the received network slice group priority validity. The network slice priority validity and the network slice group priority validity may be same to the network slice priority validity and the network slice group priority validity in Variants 2, 3 and 4 of the first Example of the first Aspect. The UE stores the validity parameter for each network slice priority and the validity for each network slice group priority along with each network slice priority and network slice group priority and the UE runs timers for each network slice and network slice group with a value equal to the validity parameter of each network slices priority and network slice group priority. The UE uses the stored network slice priority and the stored network slice group priority for the purposes of cell selection and reselection as per the description in step 7 of the Second example of the Second Aspect until the expiry of the priority validity timer for each of the network slices and network slice groups or until the next update to priority validity by the network for a network slice or a network slice group. At expiry of one or more network slice priority validity timers or network slice group priority validity timers or at update to the network slice priority validity or network slice group priority validity by the network, the UE restarts the network slice priority or network slice group priority validity timers if updated by the network for example or the UE sets the network slice priority and the network slice group priorities to a default priorities if the validity timer expires and not updated by the network. The network slice priority(ies) may be grouped in network slice group(s) and the network slice group(s) may be sent to associated node(s). The associated node(s) may be expressed as at least one of the PCF and the AMF and the UE. In this case, the network slice group may be identified with unique network slice group id and each network slice group may include one or more network slices. The network slices in the network slice group may be listed in priority order. The grouping may be performed by the UDM or the PCF or the AMF. When grouping the network slices in the network slice group(s), at least one of the criteria as mentioned in Variant 1 of First Example of the First Aspect or First Example of the Second Aspect may be used. The UE may use at least one of the received network slice priority validity and the received network slice group priority validity in the same manner as Variant 1 of First Example of the Second Aspect.

### Variant 2 of the Fourth Example of the Second Aspect

In steps 3 and 4, via the UE Policy update in the UE by the network based on the network slice priorities and the network slice group priorities, the network may control the UE registrations and more specifically the network slices for which the UE requests to register for and when the UE registers for these network slices. The UE Policy update may be expressed as at least one of the URSP rules update. The network slices for which the UE requests to register for may mean the network slices the UE includes in the Requested NSSAI. As per the current state of the art, the UE may request registration for a network slice that the UE may or may not use in the duration of the registration or may use in a very distant time. This may lead to network resources allocation without it being used by the UE. In order to optimize the use of network resources, the network may assist the UE via the UE Policy update with a list of network slice(s) the UE is recommended to register with and for how long to stay registered with. For example, the network may provide new URSP rules to the UE for example called ‘network slices for UE registration’ rules or any other notation for URSP rules for the purpose of indicating to the UE within the URSP rules information about which network slices it is suggested the UE registers for and for how long to stay registered with. This way the network may assist the UE in deciding when and for which network slices to request registration by updating the UE Policy in the UE with information which helps the UE to register for network slices which the UE is likely to use or for which the UE has compatible applications installed or active. The UE policy update may be expressed as URSP and NSSP rules, and the UE Policy may be expressed as the URSP rules. For example, the list of network slice may list one or more network slices in priority order. Thus, the UE registration for network slice may be optimised so that the UE registers for network slice which the UE is likely to use and to register for a network slice when needed. The UE may register for a network slice on a need to use bases. This would help to more efficiently use the network resources.

### Third Aspect

This disclosure discloses a mechanism that enables network slices priority information and network slices grouping information from the UE subscription information in the UDM are provided to other network nodes for which this information is applicable. Any further updates to the network slice priority or network slice grouping in the UDM triggers refreshing updates to the other network nodes that make use of the network slice priority and the network slice grouping information.

### First Example of the Third Aspect

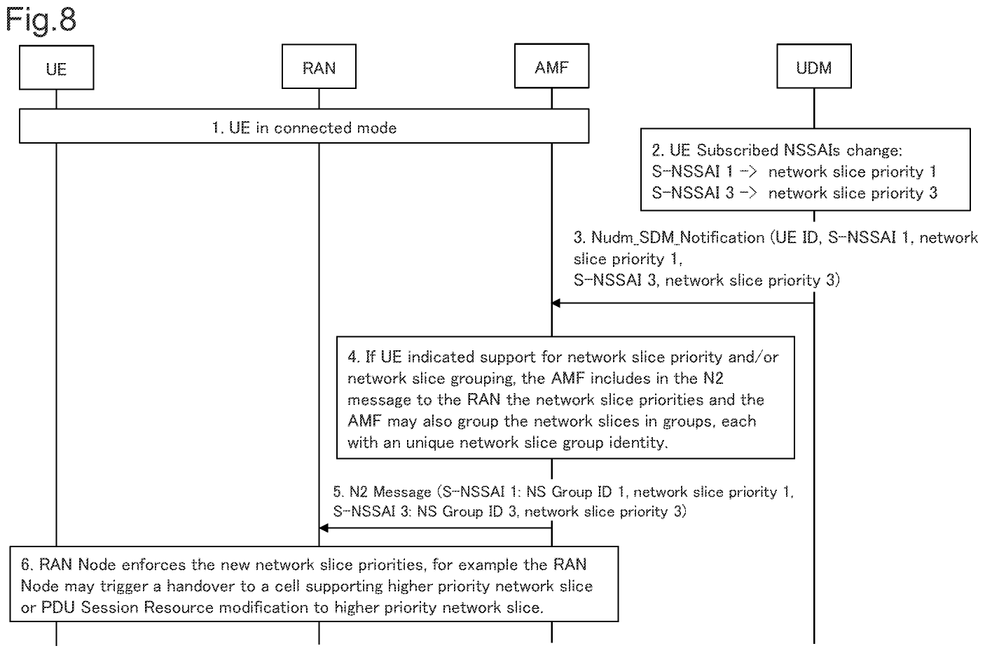

This disclosure in FIG. 8 discloses a mechanism for network slice priority information and network slice group information provisioning and further updates to a RAN Node for connected UEs. The UE may be expressed as a UE 3. The RAN Node and RAN may be expressed as a (R)AN node 5. The AMF may be expressed as an AMF 70. The UDM may be expressed as a UDM 75.

1. The UE has registered with the network and is in connected mode.

2. The UE subscribed network slice priority information in the UDM may be updated by the operator or by the service provider via the NEF. The UE subscribed network slice priority information in the UDM may be updated by processes in the first Aspect. For example, UE subscribed S-NSSAI 1 becomes of network slice priority 1 and the UE Subscribed S-NSSAI 3 becomes of network slice priority 3. For example, network slice priority 1 is assigned to UE subscribed S-NSSAI 1 and network slice priority 3 is assigned to the S-NSSAI 3.

3. When the network slice priority (or the network slice priorities) is updated in the UDM, the UDM triggers Nudm_SDM_Notification message (or any other message with the purpose of indicating a change in the UE subscription information) including UE ID, S-NSSAI 1, network slice priority 1, S-NSSAI 3 and network slice priority 3 to the AMF to update the UE context within the AMF with the new network slice priorities, for example for the UE subscribed S-NSSAI 1 with the updated network slice priority 1 and for the S-NSSAI 3 with the updated network slice priority 3. For example, the UDM sends an Nudm_SDM_Notification message including S-NSSAI 1 along with network slice priority 1 and S-NSSAI 3 along with network slice priority 3 to the AMF.

4. If the UE supports network slice priority (or network slice priority feature), the AMF includes in an N2 message to the UE the network slices for which the network slice priorities have been changed along with their new network slice priorities. The UE supporting network slice priority (or network slice priority feature) may mean the UE has indicated support for network slice priority (or network slice priority feature) in the Registration Request message when registering to the network or in any other NAS messages. If the UE has also indicated support for network slice grouping (or network slice grouping feature), the AMF may group the network slices in network slice groups where each network slice group can be identified with unique network slice group id and each network slice group may include one or more network slices. The UE supporting network slice grouping (or network slice grouping feature) may mean the UE has indicated support for network slice grouping (or network slice grouping feature) in the Registration Request message when registering to the network or in any other NAS messages. The network slices in the network slice group may be listed in priority order. The AMF may use different criteria when grouping the network slices in groups. The AMF may use criteria standardised or operator defined. Examples of the different criteria are shown below:
a criteria based on the network slice priority—For example, network slices with same or similar priority may be part of the same network slice group.; or
a criteria based on the service provided by the network slices—For example, network slices that can provide same or similar services may be part of the same network slice group, the network slices that can provide same or similar services may be expressed as the network slices with the same Slice Service Type (SST).; or
a criteria based on the network slice ownership—For example, network slices belonging to the same operator or belonging to equivalent PLMNs may be grouped in the same network slice group, the network slices belonging to the same operator may be expressed as the network slices with same Slice Differentiator (SD).; or
any other criteria for network slice grouping.

For example, in a case where the UE can recognize or understand the network slices along with their network slice priorities described below and the network slice groups described below, the UE supports at least one of the network slice priority and the network slice grouping.

5. The AMF provides the updated network slices along with their updated network slice priority and the network slice groups, each of the network slice groups identified by unique network slice group id to the RAN node within the N2 message. The AMF may provide the network slices along with their network slice priorities without the network slice groups.

For example, in a case where the UE has indicated support for network slice priority, the AMF sends, to the RAN node, an N2 message including S-NSSAI 1 along with network slice priority 1 and S-NSSAI 3 along with network slice priority 3. The RAN node may be expressed as gNB, a base station or an NG-RAN node.

For example, in a case where the UE has indicated support for network slice priority and support for network slice grouping, the AMF makes network slice group 1 including S-NSSAI 1 and network slice group 3 including S-NSSAI 3. And the AMF assigns network slice group id 1 to the network slice group 1 and assigns network slice group id 3 to the network slice group 3. Then the AMF sends, to the RAN node, an N2 message which includes the network slice group 1 including S-NSSAI 1 along with network slice priority 1 and the network slice group 3 including S-NSSAI 3 along with network slice priority 3. The AMF may include network slice group id 1 and network slice group id 3 in the N2 message.

For example, the AMF may provide, to the RAN node, information indicating that network slice priority 1 is assigned to S-NSSAI 1, and information indicating that network slice priority 3 is assigned to S-NSSAI 3. For example, the AMF may provide, to the RAN node, information indicating that S-NSSAI 1 is included in the network slice group 1 which is identified by network slice group id 1 and that network slice priority 1 is assigned to S-NSSAI 1, and information indicating that S-NSSAI 3 is included in the network slice group 3 which is identified by network slice group id 3 and that network slice priority 3 is assigned to S-NSSAI 3.

6. In a case where the RAN Node receives the N2 message, the RAN Node may update the network slice(s) along with its new priority(ies) and associated NS Group ID. The RAN Node stores the network slices provided by the network along with their network slice priorities and the network slice groups. The network may be expressed as the AMF. The RAN Node may utilise at least one of the network slice priority and grouping information for service improvement and resource optimisation purposes. The grouping information may be expressed information indicating the network slice group(s). For example, the RAN Node uses at least one of the network slice priority and the grouping information for at least one of processes as shown below. The at least one of processes may mean at least one of processes for the UE.
Handover to a cell supporting a higher priority network slice—For example, if the service requested at PDU Session establishment was available on network slices S-NSSAI 1 and S-NSSAI 3 and the RAN node selected a cell supporting S-NSSAI 1, if now a cell supporting the higher priority S-NSSAI 3 becomes available, the RAN node may trigger handover to the cell supporting the higher priority network slice S-NSSAI 3.
PDU Session resource modification—For example, if the service requested at PDU Session establishment was available on network slices S-NSSAI 1 and S-NSSAI 3 and the PDU Session was established on the higher priority network slice S-NSSAI 1, if now S-NSSAI 3 becomes higher priority than S-NSSAI 1, the RAN node may trigger PDU Session resource relocation to move the PDU Session on the network slice with higher priority S-NSSAI 3.

### Variant 1 of First Example of the Third Aspect

In step 5, the AMF may provide the network slices supported by the network and their priorities via an NG Setup Response message or via a Handover Request message or via an RRC Inactive Assistance Information message or within Core Network Assistance information or via any other message on an N2 interface between the AMF and the RAN node. For example, in step 5, the NG Setup Response message or the Handover Request message the RRC Inactive Assistance Information message or any other message on the N2 interface between the AMF and the RAN node can be applied instead of the N2 message. For example, the information transmitted to the RAN node in step 5 may be included within the Core Network Assistance information.

### Variant 2 of First Example of the Third Aspect

If the UDM holds at least one of network slice priority validity, network slice group id, network slice group priority and network slice group priority validity information as the UE subscription in step 2, step 3 includes at least one of the network slice priority validity and the network slice group priority validity to convey at least one of the network slice priority validity and the network slice group priority validity to the RAN Node. In this case, the AMF finds suitable network slices along with their updated network slice priority and the updated network slice groups priority based on at least one of the received network slice priority validity and the network slice group priority validity in step 4 and includes at least one of the network slice priority validity and the network slice group priority validity to the N2 Message in step 5. The network slice priority validity and the network slice group priority validity may be same to the network slice priority validity and the network slice group priority validity in Variants 2, 3 and 4 of the first Example of the first Aspect.

For example, if the network slice priority validity includes valid for days, the AMF checks whether today matches with the specified days and sets the network slice priority in the N2 Message accordingly. For example, the AMF sets the network slice priority in the N2 Message in a case where the AMF determines that today matches with days indicated by the network slice priority validity. The AMF sets the network slice priority and the network slice group in the N2 Message in a case where the AMF determines that today matches with days indicated by the network slice priority validity and the network slice group priority validity.

For example, if the network slice priority validity includes specific TAI(s), the AMF checks whether a TAI of connected RAN matches with the specified TAI(s) and sets the network slice priority in the N2 Message accordingly. For example, the AMF sets the network slice priority in the N2 Message in a case where the AMF determines that a TAI of connected RAN matches with TAI(s) indicated by the network slice priority validity. The AMF sets the network slice priority and the network slice group in the N2 Message in a case where the AMF determines that a TAI of connected RAN matches with TAI(s) indicated by the network slice priority validity and the network slice group priority validity.

For example, if the network slice priority validity includes specific PLMN(s), the AMF checks whether a PLMN that the AMF belongs matches with the specified PLMN(s) and sets the network slice priority in the N2 Message accordingly. For example, the AMF sets the network slice priority in the N2 Message in a case where the AMF determines that a PLMN that the AMF belongs matches with PLMN(s) indicated by the network slice priority validity. The AMF sets the network slice priority and the network slice group in the N2 Message in a case where the AMF determines that a PLMN that the AMF belongs matches with PLMN(s) indicated by the network slice priority validity and the network slice group priority validity.

For example, if the network slice priority validity includes specific RAT type(s), the AMF checks whether a RAT type of connected RAN matches with the specified RAT type(s) and sets the network slice priority in the N2 Message accordingly. For example, the AMF sets the network slice priority in the N2 Message in a case where the AMF determines that a RAT type of connected RAN matches with RAT type(s) indicated by the network slice priority validity. The AMF sets the network slice priority and the network slice group in the N2 Message in a case where the AMF determines that a RAT type of connected RAN matches with RAT type(s) indicated by the network slice priority validity and the network slice group priority validity.

### System Overview

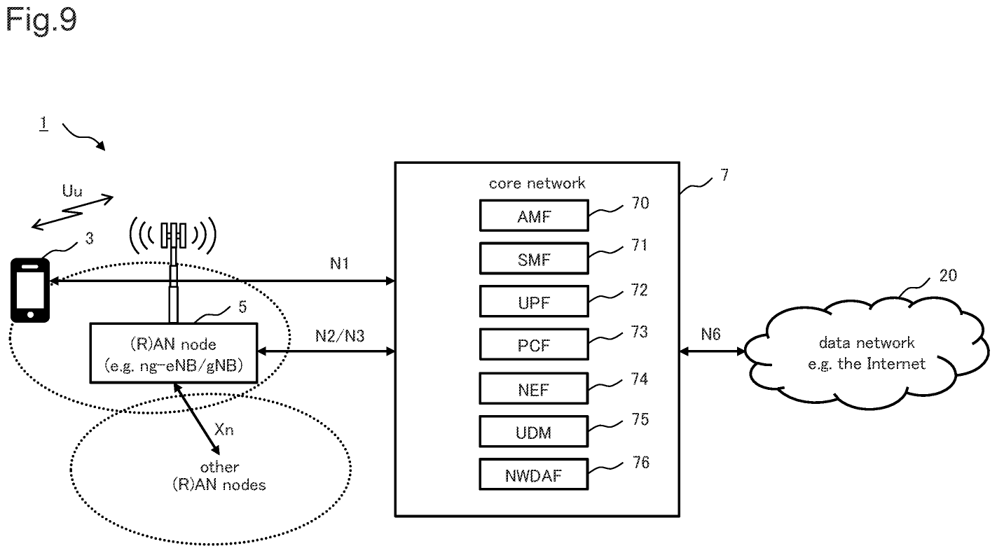

FIG. 9 schematically illustrates a telecommunication system 1 for a mobile (cellular or wireless) to which the above aspects are applicable.

The telecommunication system 1 represents a system overview in which an end to end communication is possible. For example, UE 3 (or user equipment, ‘mobile device’ 3) communicates with other UEs 3 or service servers in the data network 20 via respective (R)AN nodes 5 and a core network 7.

The (R)AN node 5 supports any radio accesses including a 5G radio access technology (RAT), an E-UTRA radio access technology, a beyond 5G RAT, a 6G RAT and non-3GPP RAT including wireless local area network (WLAN) technology as defined by the Institute of Electrical and Electronics Engineers (IEEE)

The (R)AN node 5 may split into a Radio Unit (RU), Distributed Unit (DU) and Centralized Unit (CU). In some aspects, each of the units may be connected to each other and structure the (R)AN node 5 by adopting an architecture as defined by the Open RAN (O-RAN) Alliance, where the units above are referred to as O-RU, O-DU and O-CU respectively.

The (R)AN node 5 may be split into control plane function and user plane function. Further, multiple user plane functions can be allocated to support a communication. In some aspects, user traffic may be distributed to multiple user plane functions and user traffic over each user plane functions are aggregated in both the UE 3 and the (R)AN node 5. This split architecture may be called as ‘dual connectivity’ or ‘Multi connectivity’.

The (R)AN node 5 can also support a communication using the satellite access. In some aspects, the (R)AN node 5 may support a satellite access and a terrestrial access.

In addition, the (R)AN node 5 can also be referred as an access node for a non-wireless access. The non-wireless access includes a fixed line access as defined by the Broadband Forum (BBF) and an optical access as defined by the Innovative Optical and Wireless Network (IOWN).

The core network 7 may include logical nodes (or ‘functions’) for supporting a communication in the telecommunication system 1. For example, the core network 7 may be 5G Core Network (5GC) that includes, amongst other functions, control plane functions and user plane functions. Each function in logical nodes can be considered as a network function. The network function may be provided to another node by adapting the Service Based Architecture (SBA).

A Network Function can be deployed as distributed, redundant, stateless, and scalable that provides the services from several locations and several execution instances in each location by adapting the network virtualization technology as defined by the European Telecommunications Standards Institute, Network Functions Virtualization (ETSI NFV).

The core network 7 may support the Non-Public Network (NPN). The NPN may be a Stand-alone Non-Public Network (SNPN) or a Public Network Integrated NPN (PNI-NPN).

As is well known, a UE 3 may enter and leave the areas (i.e. radio cells) served by the (R)AN node 5 as the UE 3 is moving around in the geographical area covered by the telecommunication system 1. In order to keep track of the UE 3 and to facilitate movement between the different (R)AN nodes 5, the core network 7 comprises at least one access and mobility management function (AMF) 70. The AMF 70 is in communication with the (R)AN node 5 coupled to the core network 7. In some core networks, a mobility management entity (MME) or a mobility management node for beyond 5G or a mobility management node for 6G may be used instead of the AMF 70.

The core network 7 also includes, amongst others, a Session Management Function (SMF) 71, a User Plane Function (UPF) 72, a Policy Control Function (PCF) 73, a Network Exposure Function (NEF) 74, a Unified Data Management (UDM) 75, and a Network Data Analytics Function (NWDAF) 76. When the UE 3 is roaming to a visited Public Land Mobile Network (VPLMN), a home Public Land Mobile Network (HPLMN) of the UE 3 provides the UDM 75 and at least some of the functionalities of the SMF 71, UPF 72, and PCF 73 for the roaming-out UE 3.

The UE 3 and a respective serving (R)AN node 5 are connected via an appropriate air interface (for example the so-called “Uu” interface and/or the like). Neighboring (R)AN node 5 are connected to each other via an appropriate (R)AN node 5 to (R)AN node interface (such as the so-called “Xn” interface and/or the like). Each (R)AN node 5 is also connected to nodes in the core network 7 (such as the so-called core network nodes) via an appropriate interface (such as the so-called “N2”/“N3” interface(s) and/or the like). From the core network 7, connection to a data network 20 is also provided. The data network 20 can be an internet, a public network, an external network, a private network or an internal network of the PLMN. In case that the data network 20 is provided by a PLMN operator or Mobile Virtual Network Operator (MVNO), the IP Multimedia Subsystem (IMS) service may be provided by that data network 20. The UE 3 can be connected to the data network 20 using IPv4, IPv6, IPv4v6, Ethernet or unstructured data type.

The “Uu” interface may include a Control plane of Uu interface and User plane of Uu interface.

The User plane of Uu interface is responsible to convey user traffic between the UE 3 and a serving (R)AN node 5. The User plane of Uu interface may have a layered structure with SDAP, PDCP, RLC and MAC sublayer over the physical connection.

The Control plane of Uu interface is responsible to establish, modify and release a connection between the UE 3 and a serving (R)AN node 5. The Control plane of Uu interface may have a layered structure with RRC, PDCP, RLC and MAC sublayers over the physical connection.

For example, the following messages are communicated over the RRC layer to support AS signaling.
RRC Setup Request message: This message is sent from the UE 3 to the (R)AN node 5. In addition to the parameters that are disclosed by Aspects in this disclosure, following parameters may be included together in the RRC Setup Request message.
   establishmentCause and ue-Identity. The ue-Identity may have a value of ng-5G-S-TMSI-Part1 or randomValue.
RRC Setup message: This message is sent from the (R)AN node 5 to the UE 3. In addition to the parameters that are disclosed by Aspects in this disclosure, following parameters may be included together in the RRC Setup message.
   masterCellGroup and radioBearerConfig
RRC setup complete message: This message is sent from the UE 3 to the (R)AN node 5. In addition to the parameters that are disclosed by Aspects in this disclosure, following parameters may be included together in the RRC setup complete message.
   guami-Type, iab-NodeIndication, idleMeasAvailable, mobilityState, ng-5G-S-TMSI-Part2, registeredAMF, selectedPLMN-Identity

The UE 3 and the AMF 70 are connected via an appropriate interface (for example the so-called N1 interface and/or the like). The N1 interface is responsible to provide a communication between the UE 3 and the AMF 70 to support NAS signaling. The N1 interface may be established over a 3GPP access and over a non-3GPP access. For example, the following messages are communicated over the N1 interface.
registration request message: This message is sent from the UE 3 to the AMF 70. In addition to the parameters that are disclosed by Aspects in this disclosure, following parameters may be included together in the registration request message.
5GS registration type, ngKSI, 5GS mobile identity, Non-current native NAS key set identifier, 5GMM capability, UE security capability, Requested NSSAI, Last visited registered TAI, Si UE network capability, Uplink data status, PDU session status, MICO indication, UE status, Additional GUTI, Allowed PDU session status, UE's usage setting, Requested DRX parameters, EPS NAS message container, LADN indication, Payload container type, Payload container, Network slicing indication, 5GS update type, Mobile station classmark 2, Supported codecs, NAS message container, EPS bearer context status, Requested extended DRX parameters, T3324 value, UE radio capability ID, Requested mapped NSSAI, Additional information requested, Requested WUS assistance information, N5GC indication and Requested NB-N1 mode DRX parameters.
registration accept message: This message is sent from the AMF 70 to the UE 3. In addition to the parameters that are disclosed by Aspects in this disclosure, following parameters may be included together in the registration accept message.
5GS registration result, 5G-GUTI, Equivalent PLMNs, TAI list, Allowed NSSAI, Rejected NSSAI, Configured NSSAI, 5GS network feature support, PDU session status, PDU session reactivation result, PDU session reactivation result error cause, LADN information, MICO indication, Network slicing indication, Service area list, T3512 value, Non-3GPP de-registration timer value, T3502 value, Emergency number list, Extended emergency number list, SOR transparent container, EAP message, NSSAI inclusion mode, Operator-defined access category definitions, Negotiated DRX parameters, Non-3GPP NW policies, EPS bearer context status, Negotiated extended DRX parameters, T3447 value, T3448 value, T3324 value, UE radio capability ID, UE radio capability ID deletion indication, Pending NSSAI, Ciphering key data, CAG information list, Truncated 5G-S-TMSI configuration, Negotiated WUS assistance information, Negotiated NB-N1 mode DRX parameters and Extended rejected NSSAI.
Registration Complete message: This message is sent from the UE 3 to the AMF 70. In addition to the parameters that are disclosed by Aspects in this disclosure, following parameters may be included together in the Registration Complete message.
SOR transparent container.
Authentication Request message: This message is sent from the AMF 70 to the UE 3. In addition to the parameters that are disclosed by Aspects in this disclosure, following parameters may be included together in the Authentication Request message.
ngKSI,ABBA, Authentication parameter RAND (5G authentication challenge), Authentication parameter AUTN (5G authentication challenge) and EAP message.
Authentication Response message: This message is sent from the UE 3 to the AMF 70. In addition to the parameters that are disclosed by Aspects in this disclosure, following parameters may be populated together in the Authentication Response message.
Authentication response message identity, Authentication response parameter and EAP message.
Authentication Result message: This message is sent from the AMF 70 to the UE 3. In addition to the parameters that are disclosed by Aspects in this disclosure, following parameters may be populated together in the Authentication Result message.
ngKSI, EAP message and ABBA.
Authentication Failure message: This message is sent from the UE 3 to the AMF 70. In addition to the parameters that are disclosed by Aspects in this disclosure, following parameters may be populated together in the Authentication Failure message.
Authentication failure message identity, 5GMM cause and Authentication failure parameter.
Authentication Reject message: This message is sent from the AMF 70 to the UE 3. In addition to the parameters that are disclosed by Aspects in this disclosure, following parameters may be populated together in the Authentication Reject message.
EAP message.
Service Request message: This message is sent from the UE 3 to the AMF 70. In addition to the parameters that are disclosed by Aspects in this disclosure, following parameters may be populated together in the Service Request message.
ngKSI, Service type, 5G-S-TMSI, Uplink data status, PDU session status, Allowed PDU session status, NAS message container.
Service Accept message: This message is sent from the AMF 70 to the UE 3. In addition to the parameters that are disclosed by Aspects in this disclosure, following parameters may be populated together in the Service Accept message.
PDU session status, PDU session reactivation result, PDU session reactivation result error cause, EAP message and T3448 value.
Service Reject message: This message is sent from the AMF 70 to the UE 3. In addition to the parameters that are disclosed by Aspects in this disclosure, following parameters may be populated together in the Service Reject message.
5GMM cause, PDU session status, T3346 value, EAP message, T3448 value and CAG information list.
Configuration Update Command message: This message is sent from the AMF 70 to the UE 3. In addition to the parameters that are disclosed by Aspects in this disclosure, following parameters may be populated together in the Configuration Update Command message.
Configuration update indication, 5G-GUTI, TAI list, Allowed NSSAI, Service area list, Full name for network, Short name for network, Local time zone, Universal time and local time zone, Network daylight saving time, LADN information, MICO indication, Network slicing indication, Configured NSSAI, Rejected NSSAI, Operator-defined access category definitions, SMS indication, T3447 value, CAG information list, UE radio capability ID, UE radio capability ID deletion indication, 5GS registration result, Truncated 5G-S-TMSI configuration, Additional configuration indication and Extended rejected NSSAI.
Configuration Update Complete message: This message is sent from the UE 3 to the AMF 70. In addition to the parameters that are disclosed by Aspects in this disclosure, following parameters may be populated together in the Configuration Update Complete message.
Configuration update complete message identity.

### <User Equipment (UE)>

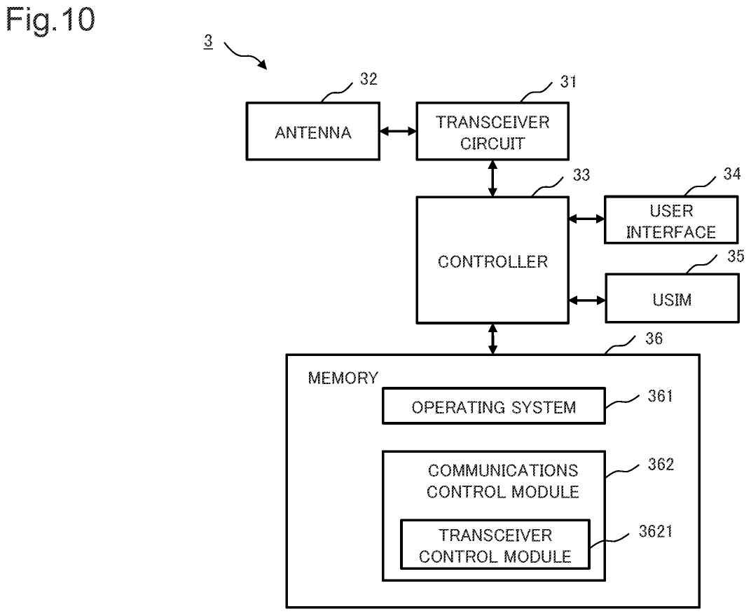

FIG. 10 is a block diagram illustrating the main components of the UE 3 (mobile device 3). As shown, the UE 3 includes a transceiver circuit 31 which is operable to transmit signals to and to receive signals from the connected node(s) via one or more antennas 32. Further, the UE 3 may include a user interface 34 for inputting information from outside or outputting information to outside. Although not necessarily shown in the Figure, the UE 3 may have all the usual functionality of a conventional mobile device and this may be provided by any one or any combination of hardware, software and firmware, as appropriate. Software may be pre-installed in the memory and/or may be downloaded via the telecommunication network or from a removable data storage device (RMD), for example. A controller 33 controls the operation of the UE 3 in accordance with software stored in a memory 36. The software includes, among other things, an operating system 361 and a communications control module 362 having at least a transceiver control module 3621. The communications control module 362 (using its transceiver control module 3621) is responsible for handling (generating/sending/receiving) signalling and uplink/downlink data packets between the UE 3 and other nodes, such as the (R)AN node 5 and the AMF 70. Such signalling may include, for example, appropriately formatted signalling messages (e.g. a registration request message and associated response messages) relating to access and mobility management procedures (for the UE 3). The controller 33 interworks with one or more Universal Subscriber Identity Module (USIM) 35. If there are multiple USIMs 35 equipped, the controller 33 may activate only one USIM 35 or may activate multiple USIMs 35 at the same time.

The UE 3 may, for example, support the Non-Public Network (NPN), The NPN may be a Stand-alone Non-Public Network (SNPN) or a Public Network Integrated NPN (PNI-NPN).

The UE 3 may, for example, be an item of equipment for production or manufacture and/or an item of energy related machinery (for example equipment or machinery such as: boilers; engines; turbines; solar panels; wind turbines; hydroelectric generators; thermal power generators; nuclear electricity generators; batteries; nuclear systems and/or associated equipment; heavy electrical machinery; pumps including vacuum pumps; compressors; fans; blowers; oil hydraulic equipment; pneumatic equipment; metal working machinery; manipulators; robots and/or their application systems; tools; molds or dies; rolls; conveying equipment; elevating equipment; materials handling equipment; textile machinery; sewing machines; printing and/or related machinery; paper converting machinery; chemical machinery; mining and/or construction machinery and/or related equipment; machinery and/or implements for agriculture, forestry and/or fisheries; safety and/or environment preservation equipment; tractors; precision bearings; chains; gears; power transmission equipment; lubricating equipment; valves; pipe fittings; and/or application systems for any of the previously mentioned equipment or machinery etc.).

The UE 3 may, for example, be an item of transport equipment (for example transport equipment such as: rolling stocks; motor vehicles; motor cycles; bicycles; trains; buses; carts; rickshaws; ships and other watercraft; aircraft; rockets; satellites; drones; balloons etc.).

The UE 3 may, for example, be an item of information and communication equipment (for example information and communication equipment such as: electronic computer and related equipment; communication and related equipment; electronic components etc.).

The UE 3 may, for example, be a refrigerating machine, a refrigerating machine applied product, an item of trade and/or service industry equipment, a vending machine, an automatic service machine, an office machine or equipment, a consumer electronic and electronic appliance (for example a consumer electronic appliance such as: audio equipment; video equipment; a loud speaker; a radio; a television; a microwave oven; a rice cooker; a coffee machine; a dishwasher; a washing machine; a dryer; an electronic fan or related appliance; a cleaner etc.).

The UE 3 may, for example, be an electrical application system or equipment (for example an electrical application system or equipment such as: an x-ray system; a particle accelerator; radio isotope equipment; sonic equipment; electromagnetic application equipment; electronic power application equipment etc.).

The UE 3 may, for example, be an electronic lamp, a luminaire, a measuring instrument, an analyzer, a tester, or a surveying or sensing instrument (for example a surveying or sensing instrument such as: a smoke alarm; a human alarm sensor; a motion sensor; a wireless tag etc.), a watch or clock, a laboratory instrument, optical apparatus, medical equipment and/or system, a weapon, an item of cutlery, a hand tool, or the like.

The UE 3 may, for example, be a wireless-equipped personal digital assistant or related equipment (such as a wireless card or module designed for attachment to or for insertion into another electronic device (for example a personal computer, electrical measuring machine)).

The UE 3 may be a device or a part of a system that provides applications, services, and solutions described below, as to “internet of things (IoT)”, using a variety of wired and/or wireless communication technologies.

Internet of Things devices (or “things”) may be equipped with appropriate electronics, software, sensors, network connectivity, and/or the like, which enable these devices to collect and exchange data with each other and with other communication devices. IoT devices may comprise automated equipment that follow software instructions stored in an internal memory. IoT devices may operate without requiring human supervision or interaction. IoT devices might also remain stationary and/or inactive for a long period of time. IoT devices may be implemented as a part of a (generally) stationary apparatus. IoT devices may also be embedded in non-stationary apparatus (e.g. vehicles) or attached to animals or persons to be monitored/tracked.

It will be appreciated that IoT technology can be implemented on any communication devices that can connect to a communications network for sending/receiving data, regardless of whether such communication devices are controlled by human input or software instructions stored in memory.

It will be appreciated that IoT devices are sometimes also referred to as Machine-Type Communication (MTC) devices or Machine-to-Machine (M2M) communication devices or Narrow Band-IoT UE (NB-IoT UE). It will be appreciated that a UE 3 may support one or more IoT or MTC applications.

The UE 3 may be a smart phone or a wearable device (e.g. smart glasses, a smart watch, a smart ring, or a hearable device).

The UE 3 may be a car, or a connected car, or an autonomous car, or a vehicle device, or a motorcycle or V2X (Vehicle to Everything) communication module (e.g. Vehicle to Vehicle communication module, Vehicle to Infrastructure communication module, Vehicle to People communication module and Vehicle to Network communication module).

### <(R)AN Node>

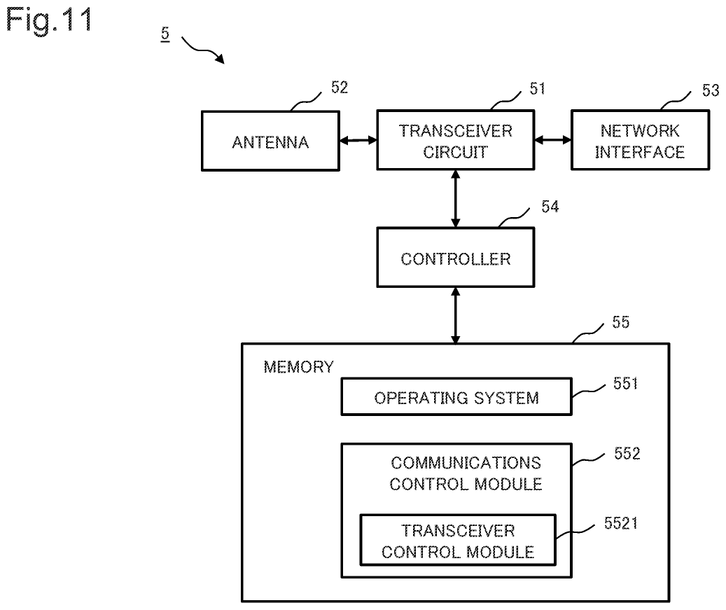

FIG. 11 is a block diagram illustrating the main components of an exemplary (R)AN node 5, for example a base station (‘eNB’ in LTE, ‘gNB’ in 5G, a base station for 5G beyond, a base station for 6G). As shown, the (R)AN node 5 includes a transceiver circuit 51 which is operable to transmit signals to and to receive signals from connected UE(s) 3 via one or more antennas 52 and to transmit signals to and to receive signals from other network nodes (either directly or indirectly) via a network interface 53. A controller 54 controls the operation of the (R)AN node 5 in accordance with software stored in a memory 55. Software may be pre-installed in the memory and/or may be downloaded via the telecommunication network or from a removable data storage device (RMD), for example. The software includes, among other things, an operating system 551 and a communications control module 552 having at least a transceiver control module 5521.

The communications control module 552 (using its transceiver control sub-module) is responsible for handling (generating/sending/receiving) signalling between the (R)AN node 5 and other nodes, such as the UE 3, another (R)AN node 5, the AMF 70 and the UPF 72 (e.g. directly or indirectly). The signalling may include, for example, appropriately formatted signalling messages relating to a radio connection and a connection with the core network 7 (for a particular UE 3), and in particular, relating to connection establishment and maintenance (e.g. RRC connection establishment and other RRC messages), NG Application Protocol (NGAP) messages (i.e. messages by N2 reference point) and Xn application protocol (XnAP) messages (i.e. messages by Xn reference point), etc. Such signalling may also include, for example, broadcast information (e.g. Master Information and System information) in a sending case.

The controller 54 is also configured (by software or hardware) to handle related tasks such as, when implemented, UE mobility estimate and/or moving trajectory estimation.

The (R)AN node 5 may support the Non-Public Network (NPN), The NPN may be a Stand-alone Non-Public Network (SNPN) or a Public Network Integrated NPN (PNI-NPN).

### <System Overview of (R)AN Node 5 Based on O-RAN Architecture>

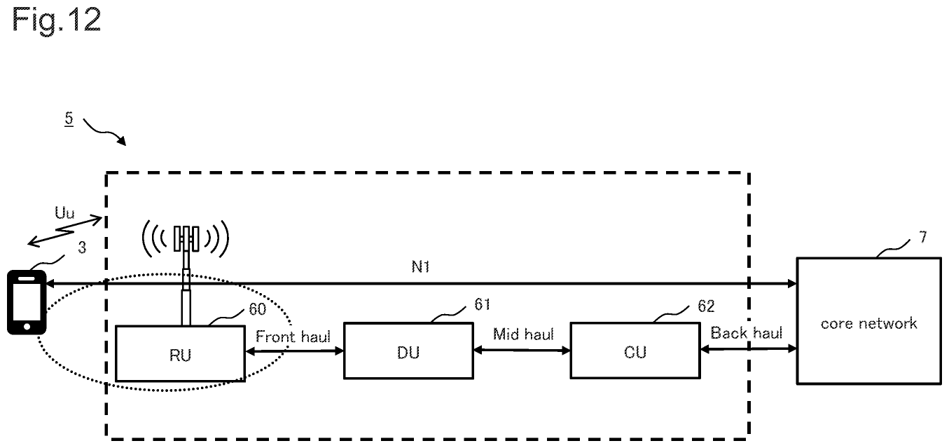

FIG. 12 schematically illustrates a (R)AN node 5 based on O-RAN architecture to which the (R)AN node 5 aspects are applicable.

The (R)AN node 5 based on O-RAN architecture represents a system overview in which the (R)AN node is split into a Radio Unit (RU) 60, Distributed Unit (DU) 61 and Centralized Unit (CU) 62. In some aspects, each unit may be combined. For example, the RU 60 can be integrated/combined with the DU 61 as an integrated/combined unit, the DU 61 can be integrated/combined with the CU 62 as another integrated/combined unit. Any functionality in the description for a unit (e.g. one of RU 60, DU 61 and CU 62) can be implemented in the integrated/combined unit above. Further, CU 62 can separate into two functional units such as CU Control plane (CP) and CU User plane (UP). The CU CP has a control plane functionality in the (R)AN node 5. The CU UP has a user plane functionality in the (R)AN node 5. Each CU CP is connected to the CU UP via an appropriate interface (such as the so-called “E1” interface and/or the like).

The UE 3 and a respective serving RU 60 are connected via an appropriate air interface (for example the so-called “Uu” interface and/or the like). Each RU 60 is connected to the DU 61 via an appropriate interface (such as the so-called “Front haul”, “Open Front haul”, “F1” interface and/or the like). Each DU 61 is connected to the CU 62 via an appropriate interface (such as the so-called “Mid haul”, “Open Mid haul”, “E2” interface and/or the like). Each CU 62 is also connected to nodes in the core network 7 (such as the so-called core network nodes) via an appropriate interface (such as the so-called “Back haul”, “Open Back haul”, “N2”/“N3” interface(s) and/or the like). In addition, a user plane part of the DU 61 can also be connected to the core network nodes 7 via an appropriate interface (such as the so-called “N3” interface(s) and/or the like).

Depending on functionality split among the RU 60, DU 61 and CU 62, each unit provides some of the functionality that is provided by the (R)AN node 5. For example, the RU 60 may provide functionalities to communicate with a UE 3 over air interface, the DU 61 may provide functionalities to support MAC layer and RLC layer, the CU 62 may provide functionalities to support PDCP layer, SDAP layer and RRC layer.

### <Radio Unit (RU)>

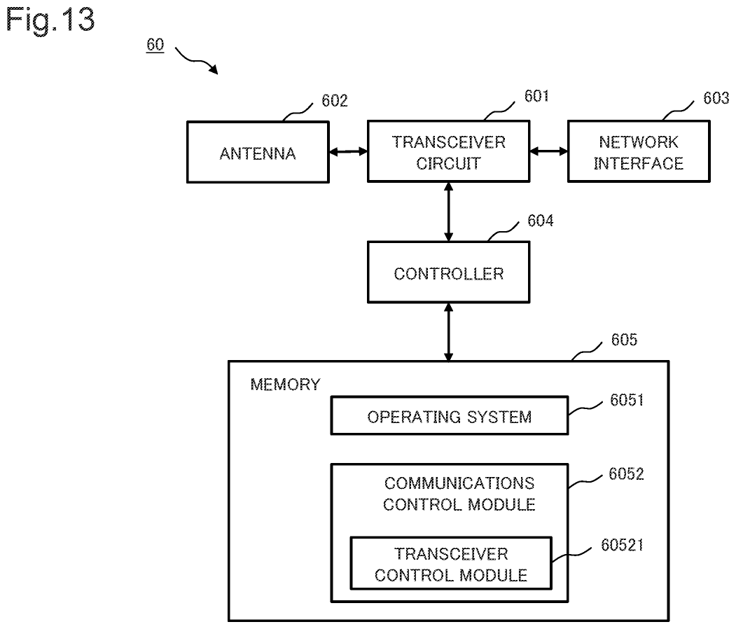

FIG. 13 is a block diagram illustrating the main components of an exemplary RU 60, for example a RU part of base station (‘eNB’ in LTE, ‘gNB’ in 5G, a base station for 5G beyond, a base station for 6G). As shown, the RU 60 includes a transceiver circuit 601 which is operable to transmit signals to and to receive signals from connected UE(s) 3 via one or more antennas 602 and to transmit signals to and to receive signals from other network nodes or network unit (either directly or indirectly) via a network interface 603. A controller 604 controls the operation of the RU 60 in accordance with software stored in a memory 605. Software may be pre-installed in the memory and/or may be downloaded via the telecommunication network or from a removable data storage device (RMD), for example. The software includes, among other things, an operating system 6051 and a communications control module 6052 having at least a transceiver control module 60521.

The communications control module 6052 (using its transceiver control sub-module) is responsible for handling (generating/sending/receiving) signalling between the RU 60 and other nodes or units, such as the UE 3, another RU 60 and DU 61 (e.g. directly or indirectly). The signalling may include, for example, appropriately formatted signalling messages relating to a radio connection and a connection with the RU 60 (for a particular UE 3), and in particular, relating to MAC layer and RLC layer.

The controller 604 is also configured (by software or hardware) to handle related tasks such as, when implemented, UE mobility estimate and/or moving trajectory estimation.

The RU 60 may support the Non-Public Network (NPN), The NPN may be a Stand-alone Non-Public Network (SNPN) or a Public Network Integrated NPN (PNI-NPN).

As described above, the RU 60 can be integrated/combined with the DU 61 as an integrated/combined unit. Any functionality in the description for the RU 60 can be implemented in the integrated/combined unit above.

### <Distributed Unit (DU)>

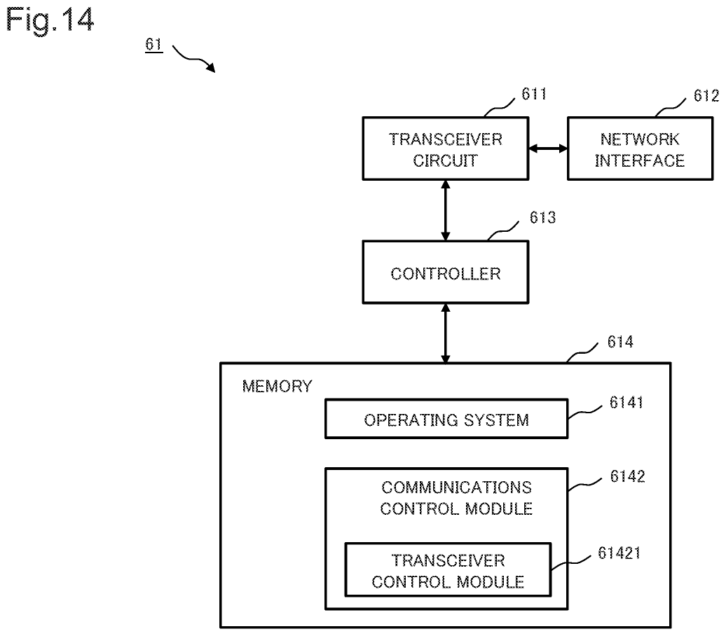

FIG. 14 is a block diagram illustrating the main components of an exemplary DU 61, for example a DU part of a base station (‘eNB’ in LTE, ‘gNB’ in 5G, a base station for 5G beyond, a base station for 6G). As shown, the apparatus includes a transceiver circuit 611 which is operable to transmit signals to and to receive signals from other nodes or units (including the RU 60) via a network interface 612. A controller 613 controls the operation of the DU 61 in accordance with software stored in a memory 614. Software may be pre-installed in the memory 614 and/or may be downloaded via the telecommunication network or from a removable data storage device (RMD), for example. The software includes, among other things, an operating system 6141 and a communications control module 6142 having at least a transceiver control module 61421. The communications control module 6142 (using its transceiver control module 61421 is responsible for handling (generating/sending/receiving) signalling between the DU 61 and other nodes or units, such as the RU 60 and other nodes and units.

The DU 61 may support the Non-Public Network (NPN), The NPN may be a Stand-alone Non-Public Network (SNPN) or a Public Network Integrated NPN (PNI-NPN).

As described above, the RU 60 can be integrated/combined with the DU 61 or CU 62 as an integrated/combined unit. Any functionality in the description for DU 61 can be implemented in one of the integrated/combined unit above.

### <Centralized Unit (CU)>

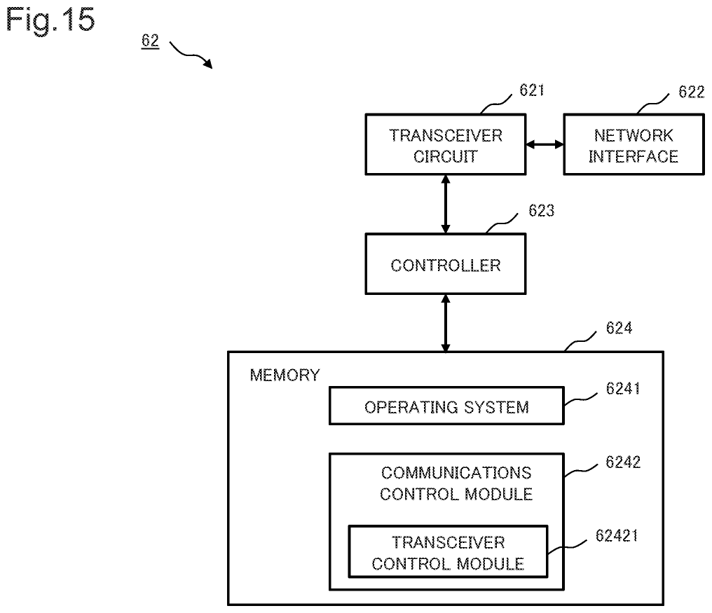

FIG. 15 is a block diagram illustrating the main components of an exemplary CU 62, for example a CU part of base station (‘eNB’ in LTE, ‘gNB’ in 5G, a base station for 5G beyond, a base station for 6G). As shown, the apparatus includes a transceiver circuit 621 which is operable to transmit signals to and to receive signals from other nodes or units (including the DU 61) via a network interface 622. A controller 623 controls the operation of the CU 62 in accordance with software stored in a memory 624. Software may be pre-installed in the memory 624 and/or may be downloaded via the telecommunication network or from a removable data storage device (RMD), for example. The software includes, among other things, an operating system 6241 and a communications control module 6242 having at least a transceiver control module 62421. The communications control module 6242 (using its transceiver control module 62421 is responsible for handling (generating/sending/receiving) signalling between the CU 62 and other nodes or units, such as the DU 61 and other nodes and units.

The CU 62 may support the Non-Public Network (NPN), The NPN may be a Stand-alone Non-Public Network (SNPN) or a Public Network Integrated NPN (PNI-NPN).

As described above, the CU 62 can be integrated/combined with the DU 61 as an integrated/combined unit. Any functionality in the description for the CU 62 can be implemented in the integrated/combined unit above.

### <AMF>

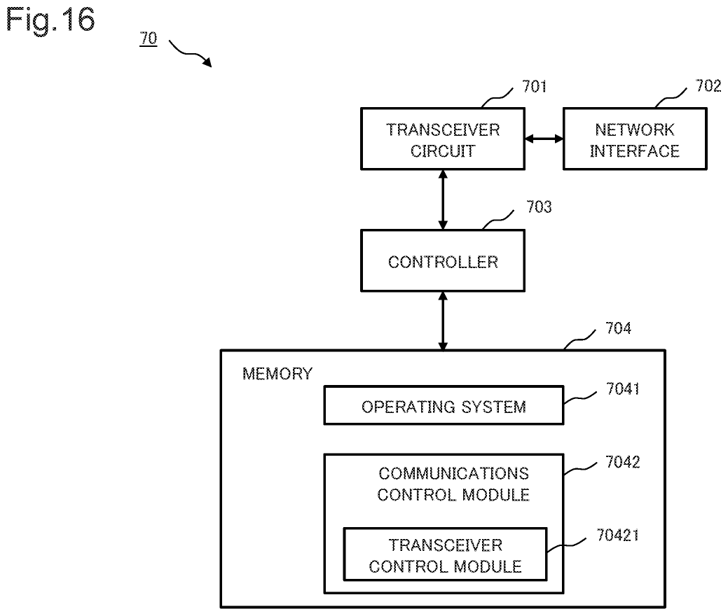

FIG. 16 is a block diagram illustrating the main components of the AMF 70. As shown, the apparatus includes a transceiver circuit 701 which is operable to transmit signals to and to receive signals from other nodes (including the UE 3) via a network interface 702. A controller 703 controls the operation of the AMF 70 in accordance with software stored in a memory 704. Software may be pre-installed in the memory 704 and/or may be downloaded via the telecommunication network or from a removable data storage device (RMD), for example. The software includes, among other things, an operating system 7041 and a communications control module 7042 having at least a transceiver control module 70421. The communications control module 7042 (using its transceiver control module 70421 is responsible for handling (generating/sending/receiving) signalling between the AMF 70 and other nodes, such as the UE 3 (e.g. via the (R)AN node 5) and other core network nodes (including core network nodes in the HPLMN of the UE 3 when the UE 3 is roaming-in. Such signalling may include, for example, appropriately formatted signalling messages (e.g. a registration request message and associated response messages) relating to access and mobility management procedures (for the UE 3).

The AMF 70 may support the Non-Public Network (NPN), The NPN may be a Stand-alone Non-Public Network (SNPN) or a Public Network Integrated NPN (PNI-NPN).

### <PCF>

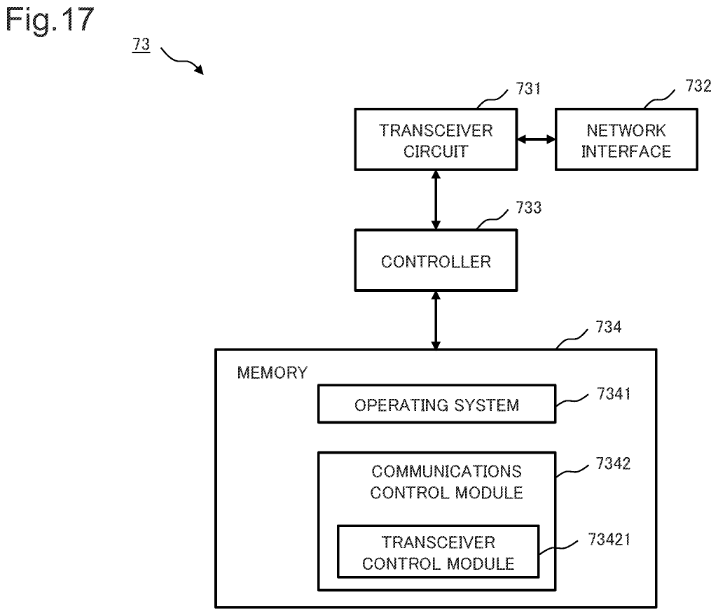

FIG. 17 is a block diagram illustrating the main components of the PCF 73. As shown, the apparatus includes a transceiver circuit 731 which is operable to transmit signals to and to receive signals from other nodes (including the AMF 70) via a network interface 732. A controller 733 controls the operation of the PCF 73 in accordance with software stored in a memory 734. Software may be pre-installed in the memory 734 and/or may be downloaded via the telecommunication network or from a removable data storage device (e.g. a removable memory device (RMD)), for example. The software includes, among other things, an operating system 7341 and a communications control module 7342 having at least a transceiver control module 73421. The communications control module 7342 (using its transceiver control module 73421 is responsible for handling (generating/sending/receiving) signalling between the PCF 73 and other nodes, such as the AMF 70 and other core network nodes (including core network nodes in the HPLMN of the UE 3 when the UE 3 is roaming-in. Such signalling may include, for example, appropriately formatted signalling messages (e.g. a HTTP restful methods based on the service based interfaces) relating to policy management procedures (for the UE 3).

The PCF 73 may support the Non-Public Network (NPN), The NPN may be a Stand-alone Non-Public Network (SNPN) or a Public Network Integrated NPN (PNI-NPN).

### <NEF>

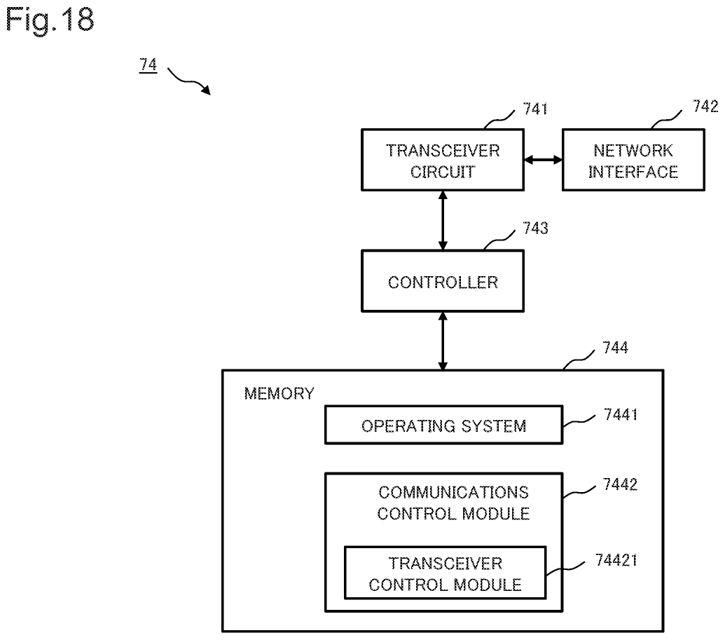

FIG. 18 is a block diagram illustrating the main components of the NEF 74. As shown, the apparatus includes a transceiver circuit 741 which is operable to transmit signals to and to receive signals from other nodes (including the UDM 75) via a network interface 742. A controller 743 controls the operation of the NEF 74 in accordance with software stored in a memory 744. Software may be pre-installed in the memory 744 and/or may be downloaded via the telecommunication network or from a removable data storage device (e.g. a removable memory device (RMD)), for example. The software includes, among other things, an operating system 7441 and a communications control module 7442 having at least a transceiver control module 74421. The communications control module 7442 (using its transceiver control module 74421 is responsible for handling (generating/sending/receiving) signalling between the NEF 74 and other nodes, such as the UDM 75 and other core network nodes (including core network nodes in the HPLMN of the UE 3 when the UE 3 is roaming-in. Such signalling may include, for example, appropriately formatted signalling messages (e.g. a HTTP restful methods based on the service based interfaces) relating to network exposure function procedures (for the UE 3).

The NEF 74 may support the Non-Public Network (NPN), The NPN may be a Stand-alone Non-Public Network (SNPN) or a Public Network Integrated NPN (PNI-NPN).

### <UDM>

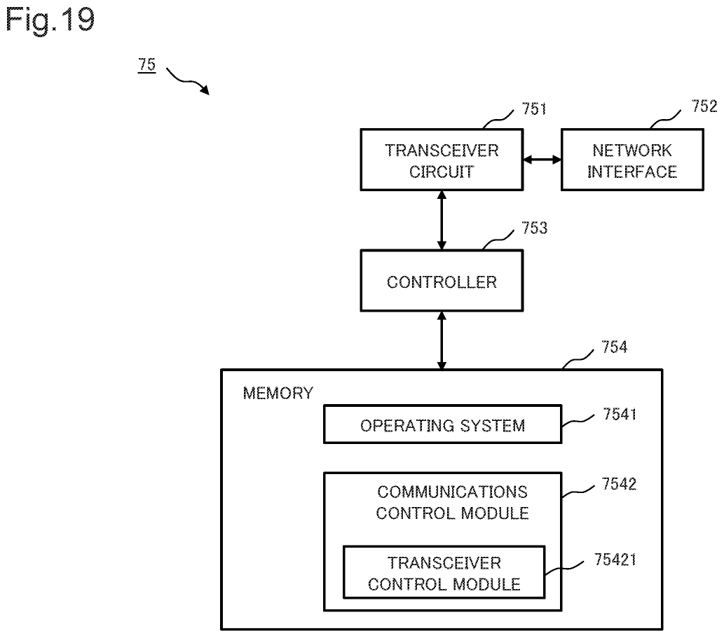

FIG. 19 is a block diagram illustrating the main components of the UDM 75. As shown, the apparatus includes a transceiver circuit 751 which is operable to transmit signals to and to receive signals from other nodes (including the AMF 70) via a network interface 752. A controller 753 controls the operation of the UDM 75 in accordance with software stored in a memory 754. Software may be pre-installed in the memory 754 and/or may be downloaded via the telecommunication network or from a removable data storage device (RMD), for example. The software includes, among other things, an operating system 7541 and a communications control module 7542 having at least a transceiver control module 75421. The communications control module 7542 (using its transceiver control module 75421 is responsible for handling (generating/sending/receiving) signalling between the UDM 75 and other nodes, such as the AMF 70 and other core network nodes (including core network nodes in the VPLMN of the UE 3 when the UE 3 is roaming-out. Such signalling may include, for example, appropriately formatted signalling messages (e.g. a HTTP restful methods based on the service based interfaces) relating to mobility management procedures (for the UE 3).

The UDM 75 may support the Non-Public Network (NPN), The NPN may be a Stand-alone Non-Public Network (SNPN) or a Public Network Integrated NPN (PNI-NPN).

### <AF>

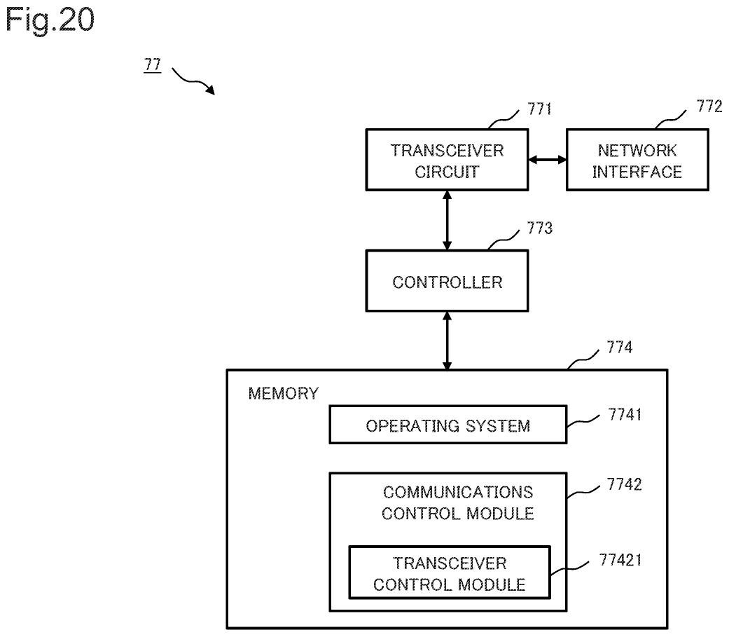

FIG. 20 is a block diagram illustrating the main components of the AF 77. As shown, the apparatus includes a transceiver circuit 771 which is operable to transmit signals to and to receive signals from other nodes (including the NEF 74) via a network interface 772. A controller 773 controls the operation of the AF 77 in accordance with software stored in a memory 774. Software may be pre-installed in the memory 774 and/or may be downloaded via the telecommunication network or from a removable data storage device (RMD), for example. The software includes, among other things, an operating system 7741 and a communications control module 7742 having at least a transceiver control module 77421. The communications control module 7742 (using its transceiver control module 77421 is responsible for handling (generating/sending/receiving) signalling between the AF 77 and other nodes, such as the NEF 74 and other core network nodes (including core network nodes in the VPLMN of the UE 3 when the UE 3 is roaming-out. Such signalling may include, for example, appropriately formatted signalling messages (e.g. a HTTP restful methods based on the service based interfaces) relating to mobility management procedures (for the UE 3).

The AF 77 may support the Non-Public Network (NPN), The NPN may be a Stand-alone Non-Public Network (SNPN) or a Public Network Integrated NPN (PNI-NPN).

### Modifications and Alternatives

Detailed aspects have been described above. As those skilled in the art will appreciate, a number of modifications and alternatives can be made to the above aspects whilst still benefiting from the disclosures embodied therein. By way of illustration only a number of these alternatives and modifications will now be described.

In the above description, the UE 3 and the network apparatus are described for ease of understanding as having a number of discrete modules (such as the communication control modules). Whilst these modules may be provided in this way for certain applications, for example where an existing system has been modified to implement the disclosure, in other applications, for example in systems designed with the inventive features in mind from the outset, these modules may be built into the overall operating system or code and so these modules may not be discernible as discrete entities. These modules may also be implemented in software, hardware, firmware or a mix of these.

Each controller may comprise any suitable form of processing circuitry including (but not limited to), for example: one or more hardware implemented computer processors; microprocessors; central processing units (CPUs); arithmetic logic units (ALUs); input/output (IO) circuits; internal memories/caches (program and/or data); processing registers; communication buses (e.g. control, data and/or address buses); direct memory access (DMA) functions; hardware or software implemented counters, pointers and/or timers; and/or the like.

In the above aspects, a number of software modules were described. As those skilled in the art will appreciate, the software modules may be provided in compiled or un-compiled form and may be supplied to the UE 3 and the network apparatus as a signal over a computer network, or on a recording medium. Further, the functionality performed by part or all of this software may be performed using one or more dedicated hardware circuits. However, the use of software modules is preferred as it facilitates the updating of the UE 3 and the network apparatus in order to update their functionalities.

In the above aspects, a 3GPP radio communications (radio access) technology is used. However, any other radio communications technology (e.g. WLAN, Wi-Fi, WiMAX, Bluetooth, etc.) and other fix line communications technology (e.g. BBF Access, Cable Access, optical access, etc.) may also be used in accordance with the above aspects.

Items of user equipment might include, for example, communication devices such as mobile telephones, smartphones, user equipment, personal digital assistants, laptop/tablet computers, web browsers, e-book readers and/or the like. Such mobile (or even generally stationary) devices are typically operated by a user, although it is also possible to connect so-called ‘Internet of Things’ (IoT) devices and similar machine-type communication (MTC) devices to the network. For simplicity, the present application refers to mobile devices (or UEs) in the description but it will be appreciated that the technology described can be implemented on any communication devices (mobile and/or generally stationary) that can connect to a communications network for sending/receiving data, regardless of whether such communication devices are controlled by human input or software instructions stored in memory.

Various other modifications will be apparent to those skilled in the art and will not be described in further detail here.

As will be appreciated by one of skill in the art, the present disclosure may be embodied as a method, and system. Accordingly, the present disclosure may take the form of an entirely hardware embodiment, a software embodiment or an embodiment combining software and hardware aspects.

It will be understood that each block of the block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. A general-purpose processor may be a microprocessor, but in the alternative, the processor may be any conventional processor, controller, microcontroller, or state machine. A processor may also be implemented as a combination of computing devices, e.g., a plurality of microprocessors, one or more microprocessors, or any other such configuration.

The methods or algorithms described in connection with the examples disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. A storage medium may be coupled to the processor such that the processor can read information from, and write information to, the storage medium. In the alternative, the storage medium may be integral to the processor. The processor and the storage medium may reside in an ASIC.

The previous description of the disclosed examples is provided to enable any person skilled in the art to make or use the present disclosure. Various modifications to these examples will be readily apparent to those skilled in the art, and the generic principles defined herein may be applied to other examples without departing from the spirit or scope of the disclosure. Thus, the present disclosure is not intended to be limited to the examples shown herein but is to be accorded the widest scope consistent with the principles and novel features disclosed herein.

While the disclosure has been particularly shown and described with reference to exemplary Aspects thereof, the disclosure is not limited to these Aspects. It will be understood by those of ordinary skill in the art that various changes in form and details may be made therein without departing from the spirit and scope of the present disclosure as defined by this document. For example, the Aspects above are not limited to 5GS, and the Aspects are also applicable to communication system other than 5GS (e.g., 6G system, 5G beyond system).

### Supplementary Notes

The whole or part of the example Aspects disclosed above can be described as, but not limited to, the following supplementary notes.

supplementary note 1. A method of an Application Function (AF) apparatus, the method comprising:
changing a priority related to Single Network Slice Selection Assistance Information (S-NSSAI); and
sending the priority to a Network Exposure Function (NEF) apparatus.

supplementary note 2. A method of a Network Exposure Function (NEF) apparatus, the method comprising:
receiving a priority related to Single Network Slice Selection Assistance Information (S-NSSAI) from an Application Function (AF) apparatus; and
sending the priority to a Unified Data Management (UDM) apparatus.

supplementary note 3. A method of a Unified Data Management (UDM) apparatus, the method comprising:
receiving a priority related to Single Network Slice Selection Assistance Information (S-NSSAI) from a Network Exposure Function (NEF) apparatus; and
storing the priority.

supplementary note 4. A method of an Access and Mobility Management Function (AMF) apparatus, the method comprising:
receiving a registration request message from a User Equipment (UE);
sending Subscription Permanent Identifier (SUPI) related to the UE to a Unified Data Management (UDM) apparatus;
receiving a priority related to Single Network Slice Selection Assistance Information (S-NSSAI) from the UDM apparatus; and
sending, to the UE, a registration accept message including the priority.

supplementary note 5. The method according to supplementary note 4, further comprising:
sending the registration accept message in a case where the registration request message including information which indicates the UE supports the priority.

supplementary note 6. A method of an Access and Mobility Management Function (AMF) apparatus, the method comprising:
receiving a priority related to Single Network Slice Selection Assistance Information (S-NSSAI) from a Unified Data Management (UDM) apparatus; and
sending, to a User Equipment (UE), a UE Configuration Update message including the priority.

supplementary note 7. The method according to supplementary note 6, further comprising:
sending the UE Configuration Update message in a case where the UE supports the priority.

supplementary note 8. A method of a User Equipment (UE), the method comprising:
sending a registration request message including information which indicates the UE supports a priority related to Single Network Slice Selection Assistance Information (S-NSSAI); and
receiving a registration accept message including the priority.

supplementary note 9. A method of a Policy Control Function (PCF) apparatus, the method comprising:
receiving a priority related to Single Network Slice Selection Assistance Information (S-NSSAI) from a Unified Data Management (UDM) apparatus;
updating a policy based on the priority; and
sending the policy.

supplementary note 10. A method of an Access and Mobility Management Function (AMF) apparatus, the method comprising:
receiving a policy including a priority related to Single Network Slice Selection Assistance Information (S-NSSAI) from a Policy Control Function (PCF) apparatus; and
sending the policy to a User Equipment (UE).

supplementary note 11. A method of an Access and Mobility Management Function (AMF) apparatus, the method comprising:
receiving Single Network Slice Selection Assistance Information (S-NSSAI) and a priority related to the S-NSSAI from a Unified Data Management (UDM) apparatus; and
sending, to a Radio Access Network (RAN) node, an N2 message including the S-NSSAI and the priority.

supplementary note 12. A method of a Radio Access Network (RAN) node, the method comprising:
receiving Single Network Slice Selection Assistance Information (S-NSSAI) and a priority related to the S-NSSAI from an Access and Mobility Management Function (AMF) apparatus; and
using the priority for a process related to handover or a process related to a PDU Session.

supplementary note 13. An Application Function (AF) apparatus comprising:
means for changing a priority related to Single Network Slice Selection Assistance Information (S-NSSAI); and
means for sending the priority to a Network Exposure Function (NEF) apparatus.

supplementary note 14. A Network Exposure Function (NEF) apparatus comprising:
means for receiving a priority related to Single Network Slice Selection Assistance Information (S-NSSAI) from an Application Function (AF) apparatus; and
means for sending the priority to a Unified Data Management (UDM) apparatus.

supplementary note 15. A Unified Data Management (UDM) apparatus comprising:
means for receiving a priority related to Single Network Slice Selection Assistance Information (S-NSSAI) from a Network Exposure Function (NEF) apparatus; and
means for storing the priority.

supplementary note 16. An Access and Mobility Management Function (AMF) apparatus comprising:
means for receiving a registration request message from a User Equipment (UE);
means for sending Subscription Permanent Identifier (SUPI) related to the UE to a Unified Data Management (UDM) apparatus;
means for receiving a priority related to Single Network Slice Selection Assistance Information (S-NSSAI) from the UDM apparatus; and
means for sending, to the UE, a registration accept message including the priority.

supplementary note 17. The AMF apparatus according to supplementary note 16, further comprising:
means for sending the registration accept message in a case where the registration request message including information which indicates the UE supports the priority.

supplementary note 18. An Access and Mobility Management Function (AMF) apparatus comprising:
means for receiving a priority related to Single Network Slice Selection Assistance Information (S-NSSAI) from a Unified Data Management (UDM) apparatus; and
means for sending, to a User Equipment (UE), a UE Configuration Update message including the priority.

supplementary note 19. The AMF apparatus according to supplementary note 18, further comprising:
means for sending the UE Configuration Update message in a case where the UE supports the priority.

supplementary note 20. A User Equipment (UE) comprising:
means for sending a registration request message including information which indicates the UE supports a priority related to Single Network Slice Selection Assistance Information (S-NSSAI); and
means for receiving a registration accept message including the priority.

supplementary note 21. A Policy Control Function (PCF) apparatus comprising:
means for receiving a priority related to Single Network Slice Selection Assistance Information (S-NSSAI) from a Unified Data Management (UDM) apparatus;
means for updating a policy based on the priority; and
means for sending the policy.

supplementary note 22. An Access and Mobility Management Function (AMF) apparatus comprising:
means for receiving a policy including a priority related to Single Network Slice Selection Assistance Information (S-NSSAI) from a Policy Control Function (PCF) apparatus; and
means for sending the policy to a User Equipment (UE).

supplementary note 23. An Access and Mobility Management Function (AMF) apparatus comprising:
means for receiving Single Network Slice Selection Assistance Information (S-NSSAI) and a priority related to the S-NSSAI from a Unified Data Management (UDM) apparatus; and
means for sending, to a Radio Access Network (RAN) node, an N2 message including the S-NSSAI and the priority.

supplementary note 24. A Radio Access Network (RAN) node comprising:
means for receiving Single Network Slice Selection Assistance Information (S-NSSAI) and a priority related to the S-NSSAI from an Access and Mobility Management Function (AMF) apparatus; and
means for using the priority for a process related to handover or a process related to a PDU Session.

While the invention has been particularly shown and described with reference to example embodiments thereof, the invention is not limited to these embodiments. It will be understood by those of ordinary skill in the art that various changes in form and details may be made therein without departing from the spirit and scope of the present invention as defined by the claims.

This application is based upon and claims the benefit of priority from Indian provisional patent application No. 202111050762, filed on Nov. 5, 2021, the disclosure of which is incorporated herein in its entirety by reference.

### REFERENCE SIGNS LIST

1 telecommunication system
3 UE
5 (R)AN node
7 core network
20 data network
31 transceiver circuit
32 antenna
33 controller
34 user interface
35 USIM
36 memory
51 transceiver circuit
52 antenna
53 network interface
54 controller
55 memory
60 RU
61 DU
62 CU
70 AMF
71 SMF
72 UPF
73 PCF
74 NEF
75 UDM
76 NWDAF
77 AF
361 operating system
362 communications control module
551 operating system
552 communications control module
601 transceiver circuit
602 antenna
603 network interface
604 controller
605 memory
611 transceiver circuit
612 network interface
613 controller
614 memory
621 transceiver circuit
622 network interface
623 controller
624 memory
701 transceiver circuit
702 network interface
703 controller
704 memory
731 transceiver circuit
732 network interface
733 controller
734 memory
741 transceiver circuit
742 network interface
743 controller
744 memory
751 transceiver circuit
752 network interface
753 controller
754 memory
771 transceiver circuit
772 network interface
773 controller
774 memory
3621 transceiver control module
5521 transceiver control module
6051 operating system
6052 communications control module
6141 operating system
6142 communications control module
6241 operating system
6242 communications control module
7041 operating system
7042 communications control module
7341 operating system
7342 communications control module
7441 operating system
7442 communications control module
7541 operating system
7542 communications control module
7741 operating system
7742 communications control module
60521 transceiver control module
61421 transceiver control module
62421 transceiver control module
70421 transceiver control module
73421 transceiver control module
74421 transceiver control module
75421 transceiver control module
77421 transceiver control module

What is claimed is:

1. A method of an Application Function (AF) apparatus, the method comprising:
changing a priority related to Single Network Slice Selection Assistance Information (S-NSSAI); and
sending the priority to a Network Exposure Function (NEF) apparatus.

2. A method of a Network Exposure Function (NEF) apparatus, the method comprising:
receiving a priority related to Single Network Slice Selection Assistance Information (S-NSSAI) from an Application Function (AF) apparatus; and
sending the priority to a Unified Data Management (UDM) apparatus.

3. A method of a Unified Data Management (UDM) apparatus, the method comprising:
receiving a priority related to Single Network Slice Selection Assistance Information (S-NSSAI) from a Network Exposure Function (NEF) apparatus; and
storing the priority.

4. A method of an Access and Mobility Management Function (AMF) apparatus, the method comprising:
receiving a registration request message from a User Equipment (UE);
sending Subscription Permanent Identifier (SUPI) related to the UE to a Unified Data Management (UDM) apparatus;
receiving first information related to Single Network Slice Selection Assistance Information (S-NSSAI) from the UDM apparatus; and
sending, to the UE, a registration accept message including a priority related to the S-NSSAI which is determined based on the first information.

5. The method according to claim 4, further comprising:
sending the registration accept message including the priority related to the S-NSSAI in a case where the registration request message including information which indicates the UE supports the priority.

6. A method of an Access and Mobility Management Function (AMF) apparatus, the method comprising:
receiving first information related to Single Network Slice Selection Assistance Information (S-NSSAI) from a Unified Data Management (UDM) apparatus; and
sending, to a User Equipment (UE), a UE Configuration Update message including a priority related to the S-NSSAI which is determined based on the first information.

7. The method according to claim 6, further comprising:
sending the UE Configuration Update message including the priority related to the S-NSSAI in a case where the UE supports the priority.

8. A method of a User Equipment (UE), the method comprising:
sending a registration request message including information which indicates the UE supports a priority related to Single Network Slice Selection Assistance Information (S-NSSAI); and
receiving a registration accept message including the priority or UE Configuration Update message including the priority.

9. A method of a Policy Control Function (PCF) apparatus, the method comprising:
receiving a priority related to Single Network Slice Selection Assistance Information (S-NSSAI) from a Unified Data Management (UDM) apparatus;
updating a policy based on the priority; and
sending the policy.

10. A method of an Access and Mobility Management Function (AMF) apparatus, the method comprising:
receiving a policy including a priority related to Single Network Slice Selection Assistance Information (S-NSSAI) from a Policy Control Function (PCF) apparatus; and
sending the policy to a User Equipment (UE).

11. A method of an Access and Mobility Management Function (AMF) apparatus, the method comprising:
receiving a priority related to Single Network Slice Selection Assistance Information (S-NSSAI) from a Unified Data Management (UDM) apparatus; and
sending, to a Radio Access Network (RAN) node, an N2 message including the priority.

12. A method of a Radio Access Network (RAN) node, the method comprising:
receiving a priority related to Single Network Slice Selection Assistance Information (S-NSSAI) from an Access and Mobility Management Function (AMF) apparatus; and
using the priority for a process related to handover or a process related to a PDU Session.

13. An Application Function (AF) apparatus comprising one or more memories storing instructions and one or more processors configured to execute the instructions to:
change a priority related to Single Network Slice Selection Assistance Information (S-NSSAI); and
send the priority to a Network Exposure Function (NEF) apparatus.

14. A Network Exposure Function (NEF) apparatus comprising one or more memories storing instructions and one or more processors configured to execute the instructions to:
receive a priority related to Single Network Slice Selection Assistance Information (S-NSSAI) from an Application Function (AF) apparatus; and
send the priority to a Unified Data Management (UDM) apparatus.

15. A Unified Data Management (UDM) apparatus comprising one or more memories storing instructions and one or more processors configured to execute the instructions to:
receive a priority related to Single Network Slice Selection Assistance Information (S-NSSAI) from a Network Exposure Function (NEF) apparatus; and
store the priority.

16. An Access and Mobility Management Function (AMF) apparatus comprising one or more memories storing instructions and one or more processors configured to execute the instructions to:
receive a registration request message from a User Equipment (UE);
send Subscription Permanent Identifier (SUPI) related to the UE to a Unified Data Management (UDM) apparatus;
receive first information related to Single Network Slice Selection Assistance Information (S-NSSAI) from the UDM apparatus; and
send, to the UE, a registration accept message including a priority related to the S-NSSAI which is determined based on the first information.

17. The AMF apparatus according to claim 16, wherein the one or more processors are configured to execute the instructions to:
send the registration accept message including the priority related to the S-NSSAI in a case where the registration request message including information which indicates the UE supports the priority.

18. An Access and Mobility Management Function (AMF) apparatus comprising one or more memories storing instructions and one or more processors configured to execute the instructions to:
receive first information related to Single Network Slice Selection Assistance Information (S-NSSAI) from a Unified Data Management (UDM) apparatus; and
send, to a User Equipment (UE), a UE Configuration Update message including a priority related to the S-NSSAI which is determined based on the first information.

19. The AMF apparatus according to claim 18, wherein the one or more processors are configured to execute the instructions to:
send the UE Configuration Update message including the priority related to the S-NSSAI in a case where the UE supports the priority.

20. A User Equipment (UE) comprising one or more memories storing instructions and one or more processors configured to execute the instructions to:
send a registration request message including information which indicates the UE supports a priority related to Single Network Slice Selection Assistance Information (S-NSSAI); and
receive a registration accept message including the priority or UE Configuration Update message including the priority.

21. A Policy Control Function (PCF) apparatus comprising one or more memories storing instructions and one or more processors configured to execute the instructions to:
receive a priority related to Single Network Slice Selection Assistance Information (S-NSSAI) from a Unified Data Management (UDM) apparatus;
update a policy based on the priority; and
send the policy.

22. An Access and Mobility Management Function (AMF) apparatus comprising one or more memories storing instructions and one or more processors configured to execute the instructions to:
receive a policy including a priority related to Single Network Slice Selection Assistance Information (S-NSSAI) from a Policy Control Function (PCF) apparatus; and
send the policy to a User Equipment (UE).

23. An Access and Mobility Management Function (AMF) apparatus comprising one or more memories storing instructions and one or more processors configured to execute the instructions to:
receive a priority related to Single Network Slice Selection Assistance Information (S-NSSAI) from a Unified Data Management (UDM) apparatus; and
send, to a Radio Access Network (RAN) node, an N2 message including the S NSSAI and the priority.

24. A Radio Access Network (RAN) node comprising one or more memories storing instructions and one or more processors configured to execute the instructions to:
receive a priority related to Single Network Slice Selection Assistance Information (S-NSSAI) from an Access and Mobility Management Function (AMF) apparatus; and
use the priority for a process related to handover or a process related to a PDU Session.

25. The method according to claim 8, further comprising:
using the priority for at least one of a cell selection or a cell reselection.

26. The UE according to claim 20, wherein the one or more processors are configured to execute the instructions to:
use the priority for at least one of a cell selection or a cell reselection.
